(19) United States
(12) Patent Application Publication
(10) Pub. No.: US 2025/0145542 A1
(43) Pub. Date: May 8, 2025

(54) METHODS FOR THE PRODUCTION OF NITROGEN FERTILIZER AND NITROGEN-SULFUR FERTILIZER

(71) Applicant: TESSENDERLO GROUP NV, Brussels (BE)

(72) Inventors: Jeroen VAN CAUWENBERGH, Brussels (BE); Lien TELEN, Brussels (BE); Mark BROUWER, Maastricht (NL); Jan VANDENDRIESSCHE, Brussels (BE)

(73) Assignee: TESSENDERLO GROUP NV, Brussels (BE)

(21) Appl. No.: 18/839,072

(22) PCT Filed: Feb. 21, 2023
(86) PCT No.: PCT/EP2023/054323

§ 371 Date: Aug. 16, 2024

(30) Foreign Application Priority Data
Feb. 22, 2022 (EP) 22158043.4

(51) Int. Cl. C05C 9/00; C05G 5/12

(52) U.S. Cl. CPC C05C 9/005; C05G 5/12

(57) ABSTRACT

The present invention relates to methods for the co-production of urea-based solid nitrogen fertilizer and urea-based solid nitrogen-sulfur fertilizer wherein urea recovered from a gas stream obtained from regular urea production is recycled and used to produce nitrogen-sulfur fertilizer containing a nitrification/urease inhibiting sulfur compound selected from thiosulphate salts, (bi)sulfite salts, polysulfide salts, (bi)sulfide salts, metabisulfite salts, dithionite salts, elemental sulfur and combinations thereof, preferably selected from the group consisting of thiosulphate salts, (bi)sulfite salts, polysulfide salts and combinations thereof. The present invention further relates to certain fertilizer compositions obtainable by the methods of the invention wherein ammonium sulphate and/or ammonium nitrate is further produced from the gas stream and combined to make a nitrogen-sulfur fertilizer.

### FIELD OF THE INVENTION

The present invention relates to methods for the co-production of urea-based solid nitrogen fertilizer and urea-based solid nitrogen-sulfur fertilizer. The present invention further relates to certain fertilizer compositions obtainable by the methods of the invention.

### BACKGROUND OF THE INVENTION

Urea (CO(NH₂)₂) is a known nitrogen fertilizer which has the highest nitrogen content of all solid nitrogenous fertilizers in common use. More than 90% of world industrial production of urea is destined for use as a fertilizer.

Industrial production of urea is well known and based on a high-temperature, high-pressure reaction of carbon dioxide and ammonia to form ammonium carbamate, and subsequent decomposition of the ammonium carbamate to form urea and water. This process is performed in dedicated urea synthesis plants, with optimized recycling of reagents and side-products and energy recuperation.

Generally, after urea synthesis, the aqueous urea solution obtained is passed through one or more recovery sections where it is concentrated and non-converted reactants are recovered and fed back to the synthesis reactor. The urea is typically concentrated to at least 95 wt. % urea before it is fed as a high-temperature melt to e.g. a prill tower or a granulator where it is solidified into small particles (e.g. prills or granules) under the influence of a gas stream, typically ambient air. The solidifying gas stream contains dust and ammonia released from the urea melt during the cooling and solidification process, and may be treated to reduce its dust and ammonia content before it is released into the atmosphere.

In the past years, efforts have been made to react ammonia waste streams obtained from various points in an urea synthesis process with sulphuric acid, converting it into ammonium sulphate, and recovering the ammonium sulphate for use as a fertilizer.

WO2006/004424 describes the production of urea-ammonium sulphate by in-situ reaction of sulphuric acid and ammonia in an aqueous urea solution.

WO2014/188371 describes the production of ammonium sulphate by reacting ammonia recovered from the gas stream of a solidification unit in a ureaplant with sulphuric acid.

WO2018/092057 describes the production of urea-ammonium sulphate wherein part of the ammonia is obtained from the recovery section of the urea synthesis plant and the resulting ammonium sulphate is combined with an urea melt.

Sulfur is part of the so-called secondary plant nutrients and like the primary nutrients (NPK), is essential for plant health and growth, although in lesser amounts than the primary nutrients. Sulfur is termed as the secondary nutrient only to refer to its quantity, not its importance in the healthy growth of the plants and crops. Sulfur is essential for nitrogen fixation in nodules on legumes, and it is necessary in the formation of chlorophyll. Plants use sulfur for producing proteins, amino acids, enzymes, and vitamins for a healthy growth. Sulfur generates resistance to disease. Most of the sulfur in soils is found in soil in organic matter. However, it is not available to plants in this form. In order to become available to plants, the sulfur must be first released from the organic matter and go through mineralization process. The mineralization process is a result of microbial activity. In this process sulfur is converted to the sulphate form (SO₄²⁻), which is readily available to plants. Oil crops, legumes, forages and some vegetable crops require sulfur in considerable amounts. In many crops, its amount in the plant is similar to phosphorus. Although it is considered a secondary nutrient, it is now becoming recognized as the ‘fourth macronutrient’, along with nitrogen, phosphorus and potassium. Sulfur deficiency symptoms show up as light green to yellowish color. Deficient plants are small and their growth is retarded. Symptoms may vary between plant species. For example, in corn, sulfur deficiency shows up as interveinal chlorosis; in wheat, the whole plant becomes pale while the younger leaves are more chlorotic; in potatoes, spotting of leaves might occur.

Thiosulphates, polysulfides and (bi)sulfites are sulfur fertilizers known to have urease and/or nitrification inhibiting properties. They are not only highly desirable fertilizers because they provide essential sulfur to plants, they also increase the nitrogen use efficiency (NUE) of nitrogen fertilizers used in conjunction with these thiosulphates, polysulfides and/or (bi)sulfites. This property stems from their chemical nature, in particular the fact that the sulfur in these compounds is not fully oxidized. The compounds are active as inhibitors, but also less stable, compared to e.g. sulphate fertilizers which do not exhibit any nitrification or urea inhibition. Only very recently, the first efforts to combine urea and nitrification inhibiting sulfur fertilizers such as thiosulphates, polysulfides and/or (bi)sulfites into a single, convenient, solid fertilizer formulation have been made, as described in WO2021/076458. Recent research efforts have also shown that it is important to use correct ratios of nitrogen to sulfur in order to obtain nitrification inhibiting effects in real-world applications.

WO2020/033575A1 describes various solid fertilizers comprising urea and thiosulphates, polysulfides and/or (bi)sulfites and methods of their production.

The present inventors have found that a disadvantage of known methods for the production of solid fertilizers comprising urea and a sulfur fertilizer such as thiosulphates, polysulfides and/or (bi)sulfites is that, opposed to relatively stable (fully oxidized) sulphate ions, these sulfur fertilizers are prone to partially decompose during processing, even in relatively mild conditions. This generates elemental sulfur and other sulfur-containing byproducts which, when integrated into an urea synthesis process, contaminate the urea synthesis equipment and adversely affect process performance, mechanical integrity and reliability. In particular, in a conventional urea synthesis facility wherein recovery of non-converted reagents is performed, an accumulation of elemental sulfur and other sulfur-containing byproducts occurs. This may lead to deterioration of equipment, decreased urea synthesis performance, decreased process efficiency, increased maintenance etc. There is thus a need to provide alternative or improved methods for the production of these solid fertilizers.

It is an object of the present invention to provide alternative or improved methods for the production of solid fertilizers comprising urea and a sulfur fertilizer such as thiosulphates, polysulfides and/or (bi)sulfites. It is a further object of the present invention to provide such methods wherein contamination of the urea synthesis plant with sulfur-containing compounds is avoided. It is a further object of the present invention to provide such methods wherein waste streams are valorized.

### SUMMARY OF THE INVENTION

The present inventors have found that one or more objects of the invention is achieved by coproducing solid nitrogen fertilizer (e.g. urea granules or prills) and solid nitrogen-sulfur fertilizer, wherein the solid nitrogen-sulfur fertilizer is produced starting from urea dust which is recovered from the gas stream of the solidification section (e.g. prilling tower or granulator) which is used to solidify the nitrogen fertilizer. This advantageously allows facile retrofitting of an existing urea synthesis plant for the production of the solid nitrogen-sulfur fertilizer without disrupting regular urea production and avoids contamination of the urea-synthesis section, evaporation section and solidification section with elemental sulfur or other sulfur-containing byproducts. Furthermore, in traditional urea synthesis plants, the urea dust from the solidification section is typically either not recovered or seen as a waste product which is recycled back to the evaporation section in the form of an aqueous solution, resulting in additional energy consumption of the evaporator. This is avoided with the method of the present invention as the urea dust is converted into a high value nitrogen-sulfur fertilizer. By valorizing the urea dust in the method of the present invention, the addition of anti-dusting agents (typically urea-formaldehyde) to urea can also be eliminated, which allows higher quality urea (e.g. suitable for use as AdBlue® ingredient) to be produced.

Hence, in a first aspect of the present invention there is provided a method for the production of a solid nitrogen fertilizer and a solid nitrogen-sulfur fertilizer, said method comprising the following steps:
(i) synthesizing urea from ammonia and carbon dioxide thereby obtaining a liquid aqueous composition comprising urea;
(ii) concentrating the aqueous composition obtained in step (i) to obtain a liquid urea melt comprising less than 5 wt % (by total weight of the melt) water, preferably comprising more than 95 wt. % (by total weight of the melt) urea;
(iii) submitting the urea melt of step (ii) to a solidification step in a solidification section wherein the melt is converted to a particulate solid, thereby obtaining the solid nitrogen fertilizer, and recovering a gas stream comprising urea from the solidification section;
(iv) recovering urea from the gas stream of step (iii), thereby obtaining an urea recyclate;
(v) providing a composition comprising a sulfur compound selected from the group consisting of thiosulphate salts, (bi)sulfite salts, polysulfide salts, (bi)sulfide salts, metabisulfite salts, dithionite salts, elemental sulfur and combinations thereof, preferably selected from the group consisting of thiosulphate salts, (bi)sulfite salts, polysulfide salts and combinations thereof;
(vi) submitting the urea recyclate of step (iv) to a concentration step and combining the composition provided in step (v) with the urea recyclate before, during and/or after the concentration step to obtain a concentrated nitrogen-sulfur stream;
(vii) submitting the concentrated nitrogen-sulfur stream to a solidification step in a solidification section, wherein the stream is converted to a particulate solid, thereby obtaining the solid nitrogen-sulfur fertilizer.

As will be explained in detail throughout the present disclosure, the present inventors have found that the method described herein can be combined with ammonia recovery in the form of ammonium sulphate or ammonium nitrate. This leads to unique fertilizer compositions comprising urea, a sulfur compound of the present invention and an ammonium compound selected from ammonium sulphate and/or ammonium nitrate.

In another aspect of the invention there is thus provided a composition comprising at least 50 wt. % urea (by total weight of the composition), at least 10 wt. % (by total weight of the composition) of a sulfur compound selected from the group consisting of thiosulphate salts, (bi)sulfite salts and/or polysulfide salts, 5-35 wt. % (by total weight of the composition) of an ammonium compound selected from ammonium sulphate and/or ammonium nitrate, and less than 5 wt. % (by total weight of the composition) water.

### BRIEF DESCRIPTION OF THE FIGURES

The present invention will now be described in more detail with reference to specific embodiments of the invention, given only by way of illustration, and with reference to the accompanying drawings.

FIG. 1 is a schematic representation of an embodiment of the method for the production of a solid nitrogen fertilizer and a solid nitrogen-sulfur fertilizer of the present invention, illustrating a selection of different options for combining the sulfur compound with the urea recyclate.

FIG. 2 is a schematic representation of an embodiment of the method for the production of a solid nitrogen fertilizer and a solid nitrogen-sulfur fertilizer of the present invention, illustrating recovery of the urea recyclate by filters and/or cyclones to isolate urea dust followed by dissolution of the urea dust and a non-limiting selection of different options for combining the sulfur compound provided in step (v) with the urea recyclate.

FIG. 3 is a schematic representation of an embodiment of the method for the production of a solid nitrogen fertilizer and a solid nitrogen-sulfur fertilizer of the present invention, illustrating recovery of the urea recyclate by one or more scrubbers and a non-limiting selection of different options for combining the sulfur compound provided in step (v) with the urea recyclate.

FIG. 4 is a schematic representation of an embodiment of the method for the production of a solid nitrogen fertilizer and a solid nitrogen-sulfur fertilizer of the present invention, illustrating recovery of the urea recyclate by one or more scrubbers wherein the condensate from evaporating the urea recyclate stream is recycled to at least partially form the liquid phase of the scrubber and a non-limiting selection of different options for combining the sulfur compound provided in step (v) with the urea recyclate.

FIG. 5 is a schematic representation of an embodiment of the method for the production of a solid nitrogen fertilizer and a solid nitrogen-sulfur fertilizer of the present invention, illustrating recovery of the urea recyclate by filters and/or cyclones to isolate urea dust, wherein the condensate from evaporating the urea recyclate stream is recycled to at least partially form the liquid phase used to dissolve the urea dust and a non-limiting selection of different options for combining the sulfur compound provided in step (v) with the urea recyclate.

FIG. 6 is a schematic representation of an embodiment of the method for the production of a solid nitrogen fertilizer and a solid nitrogen-sulfur fertilizer of the present invention, illustrating recycling of the gas stream recovered from the solidification section producing solid nitrogen-sulfur fertilizer and combining it with the gas stream recovered from the solidification section producing solid nitrogen fertilizer before and/or during urea separation and a non-limiting selection of different options for combining the sulfur compound provided in step (v) with the urea recyclate.

FIG. 7 is a schematic representation of an embodiment of the method for the production of a solid nitrogen fertilizer and a solid nitrogen-sulfur fertilizer of the present invention, illustrating (a) recycling of the gas stream recovered from the solidification section producing solid nitrogen-sulfur fertilizer and combining it with the gas stream recovered from the solidification section producing solid nitrogen fertilizer before and/or during urea separation, combined with (b) illustrating recycling of the condensate from evaporating the urea recyclate stream to the urea separation step (e.g. filters, cyclones and/or scrubbers); and a non-limiting selection of different options for combining the sulfur compound provided in step (v) with the urea recyclate.

FIG. 8 is a schematic representation of an embodiment of the method for the production of a solid nitrogen fertilizer and a solid nitrogen-sulfur fertilizer of the present invention, illustrating recovery of urea recyclate from a first scrubber, and recovery of ammonia in the form of ammonium sulphate from the off-gas from the first scrubber by a second scrubber using an aqueous phase comprising sulphuric acid, followed by combining at least part of the ammonium sulphate stream with the urea recyclate before solidification and before, during and/or after combining the urea recyclate with sulfur compound according to the invention and a non-limiting selection of different options for combining the sulfur compound provided in step (v) with the urea recyclate.

FIG. 9 is a schematic representation of an embodiment of the method for the production of a solid nitrogen fertilizer and a solid nitrogen-sulfur fertilizer of the present invention, illustrating combination of the urea recyclate of step (iv) with part of the liquid urea melt of step (ii), before, during and/or after the concentration step (vi), and a non-limiting selection of different options for combining the sulfur compound provided in step (v) with the urea recyclate.

FIG. 10 is a schematic representation of an embodiment of the method for the production of a solid nitrogen fertilizer and a solid nitrogen-sulfur fertilizer of the present invention, illustrating combination of the urea recyclate of step (iv) with part of the liquid aqueous composition comprising urea of step (i), before, and/or during the concentration step (vi) and a non-limiting selection of different options for combining the sulfur compound provided in step (v) with the urea recyclate.

FIG. 11 illustrates the melting point of the various urea-ammonium thiosulfate mixtures of example 1.

FIG. 12 illustrates the melting point of urea-ammonium thiosulfate mixtures compared to urea-ammonium sulfate mixtures as explained in example 1.

FIG. 13 illustrates the stability of the urea-ammonium thiosulfate at different temperatures as explained in example 2.

FIG. 14 illustrates the stability of the urea-ammonium thiosulfate in granular form at different temperatures as explained in example 2.

FIG. 15 illustrates the stability of the urea-calcium thiosulfate at a temperature of 125° C. as explained in example 2.

FIG. 16 illustrates the stability of the urea-potassium thiosulfate at a temperature of 125° C. as explained in example 2.

### DETAILED DESCRIPTION

The expression “comprise” and variations thereof, such as, “comprises” and “comprising” as use herein should be construed in an open, inclusive sense, meaning that the embodiment described includes the recited features, but that it does not exclude the presence of other features, as long as they do not render the embodiment unworkable.

The expressions “one embodiment”, “a particular embodiment”, “an embodiment” etc. as used herein should be construed to mean that a particular feature, structure or characteristic described in connection with the embodiment is included in at least one embodiment. Thus, the appearances of such expressions in various places throughout this specification do not necessarily all refer to the same embodiment. Furthermore, the particular features, structures, or characteristics may be combined in any suitable manner in one or more embodiments. For example, certain features of the disclosure which are described herein in the context of separate embodiments are also explicitly envisaged in combination in a single embodiment. In particular, preferred embodiments described herein for each process steps are explicitly envisaged to be combined in order to arrive at a preferred overall process.

The singular forms “a,” “an,” and “the” as used herein should be construed to include plural referents unless the content clearly dictates otherwise. It should also be noted that the term “or” is generally employed in its broadest sense, that is as meaning “and/or” unless the content clearly dictates otherwise.

Whenever reference is made throughout this document to a compound which is a salt, this should be construed to include the anhydrous form as well as any solvates (in particular hydrates) of this compound, unless explicitly defined otherwise.

As used herein, the expression “wt. %” when used in the context of an ionic compound (such as a thiosulphate, polysulfide, (bi)sulfite or a (bi)sulphate) refers to the amount of the compound inclusive of its counterion(s).

As used herein, the expression “particulate solid” is not particularly limited to the nature of the particulate solid and in particular includes granules, prills, pellets, pastilles and powders.

As used herein, the expression “fluidized bed granulator” includes vortex granulators.

The expression “thiosulphates” or “thiosulphate salts” as used herein refers to the salts of thiosulphuric acid, which consist of one or more cations combined with a thiosulphate (S₂O₃²⁻) anion.

The expression “polysulfides” or “polysulfide salts” as used herein may refer to organic or inorganic polysulfides, but preferably refers to inorganic polysulfides, which consist of one or more cations combined with a polysulfide (Sₓ²⁻) anion.

The expression “(bi)sulfites” or “(bi)sulfite salts” as used herein refers to the salts of sulfurous acid, which consist of one or more cations combined with a sulfite (SO₃²⁻) and/or a bisulfite (HSO₃⁻) anion.

The expression “(bi)sulfides” or “(bi)sulfide salts” as used herein refers to the salts of H₂S, which consist of one or more cations combined with a sulfide (S₂₋) and/or a bisulfide (HS⁻) anion.

The expression “metabisulfites” or “metabisulfite salts” as used herein refers to salts which consist of one or more cations combined with a metabisulfite (S₂O₅²⁻) anion.

The expression “dithionites” or “dithionite salts” as used herein refers to salts which consist of one or more cations combined with a dithionite (S₂O₄²⁻) anion.

The expression “(bi)sulphates” or “(bi)sulphate salts” as used herein refers to the salts of sulphuric acid, which consist of one or more cations combined with a sulphate (SO₄²⁻) and/or a bisulphate (HSO₄) anion.

The expression “elemental sulfur” as used herein refers to compounds consisting of sulfur in oxidation state 0, typically in the form of S₈ molecules.

As will be understood by the skilled person, steps (i)-(ii) of the method of the invention describe the basic operations of a typical urea synthesis plant. The urea synthesis process is described in various handbooks and belongs to the common general knowledge of the skilled person. A brief summary can be found in WO2006/004424 page 2 fourth paragraph to page 5 first paragraph, incorporated herein by reference.

The ammonia and carbon dioxide utilized in step (i) for the synthesis of urea can originate from any source, such as the Haber-Bosch process, electrochemical production, bio-based production (e.g. fermentation by bacteria, yeast or other micro-organisms), carbon capture from gaseous process streams or the atmosphere, etc.

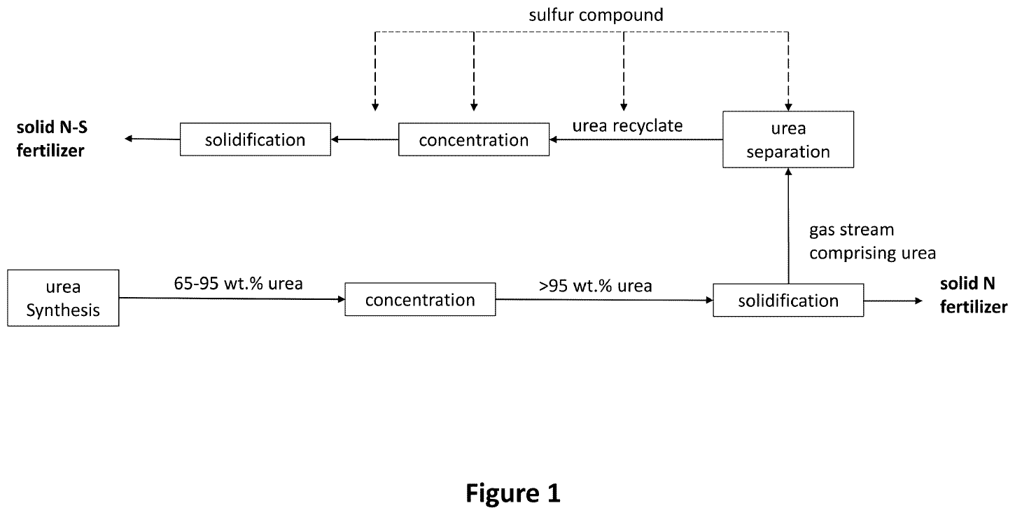

In preferred embodiments of the invention step (i) comprises at least partially separating the urea from non-converted reagents such as ammonia, carbon dioxide and ammonium carbamate in one or more recovery sections, thereby obtaining a liquid aqueous composition comprising 65-95 wt. % (by total weight of the composition) urea and at least 5 wt. % (by total weight of the composition) water, preferably obtaining a liquid aqueous composition comprising 65-75 wt. % (by total weight of the composition) urea and at least 20 wt. % (by total weight of the composition) water. FIG. 1 illustrates this preferred embodiment of the method of the invention. The composition obtained from step (i) and submitted to step (ii) preferably comprises low amounts of byproducts and additives, such as less than 10 wt. % (by total weight of the composition) of compounds other than urea and water, preferably less than 5 wt. % (by total weight of the composition) of compounds other than urea and water. Common byproducts present in the aqueous urea composition obtained in step (i) are biuret, and unconverted reagents such as ammonia, CO₂ and/or ammonium carbamate. In accordance with highly preferred embodiments of the invention, step (i) comprises at least partially separating the urea from non-converted reagents such as ammonia, carbon dioxide and ammonium carbamate, thereby obtaining a liquid aqueous composition comprising 65-95 wt. % (by total weight of the composition) urea and at least 5 wt. % (by total weight of the composition) water, preferably obtaining a liquid aqueous composition comprising 65-75 wt. % (by total weight of the composition) urea and at least 20 wt. % (by total weight of the composition) water, and further comprises recycling at least part of the non-converted reagents to the urea synthesis reaction. In such embodiments, the process of the present invention has the particular advantage that solid nitrogen-sulfur fertilizer as described herein can be produced without contamination of the urea synthesis plant by sulfur compounds of the present invention, elemental sulfur and/or other sulfur containing byproducts, and in particular without build-up in the urea synthesis plant of sulfur compounds of the present invention, elemental sulfur and/or other sulfur containing byproducts.

In highly preferred embodiments of the invention, concentration step (ii) is performed by evaporation. Step (ii) may be performed as a single or multi-stage evaporation. The type of evaporator(s) employed is not particularly limiting, and may for example be selected from the group consisting of falling-film evaporators, rising film evaporators, thin-film evaporators, wiped film evaporators, short path evaporators, forced circulation evaporators, shell-and-tube evaporators, plate evaporators, plate and frame evaporators and combinations thereof. The evaporation is preferably performed using falling-film evaporation. The evaporator(s) may be operated in known modes such as single or multiple pass, multiple-effect, employing thermal vapor recompression, employing mechanical vapor recompression, etc. In practice, step (ii) typically comprises at least two evaporation stages, each performed at a different temperature-pressure combination, in order to optimize process efficiency while avoiding solidification of urea in the evaporator (which would lead to process failure and plant shutdown). A typical scheme comprises a first evaporation step at 130° C. and a first reduced pressure (typically below 500 mbar), followed by a second evaporation step at 137-140° C. at a second reduced pressure which is lower than the first reduced pressure (typically below 100 mbar). In general it is preferred that the temperature of the urea melt is more than 128° C. when exiting the evaporator, in order to avoid solidification of urea before the process stream enters the intended solidification point (e.g. when passing cold spots). In accordance with highly preferred embodiments of the invention, step (ii) comprises concentrating the aqueous composition obtained in step (i) by evaporation and further comprises recycling at least part of the condensate to the urea synthesis reaction. In such embodiments, the process of the present invention has the particular advantage that since no sulfur compound is present in this stage of the process, solid nitrogen-sulfur fertilizer as described herein can be produced without contamination of the urea synthesis plant by sulfur compounds of the present invention, elemental sulfur and/or other sulfur containing byproducts, and in particular without build-up in the urea synthesis plant of sulfur compounds of the present invention, elemental sulfur and/or other sulfur containing byproducts.

It is particularly preferred that the embodiments of the invention described in the previous paragraphs are combined such that recycling of non-converted reagents from a recovery section and recycling of evaporator condensate both occur, as is typically the case in an integrated urea synthesis plant.

The extent of evaporation required in step (ii) is largely dependent on the maximum moisture content accepted by the solidification process employed by the solidification section of step (iii), and it is within the routine capabilities of the skilled person, based on the present disclosure, to optimize this. The liquid urea melt obtained in step (ii) comprises less than 5 wt % (by total weight of the melt) water but may comprise other compounds in addition to urea, such as fertilizing ingredients (e.g. elemental sulfur or phosphates of ammonium, alkali metals or alkaline earth metals) functional additives (e.g. urea-formaldehyde), or impurities (e.g. biuret). It is highly preferred that the liquid urea melt obtained in step (ii) comprises more than 95 wt. % (by total weight of the melt) urea. In some embodiments of the invention, step (ii) comprises concentrating the aqueous composition obtained in step (i) to obtain a liquid urea melt having a water content of less than 1 wt. % (by total weight of the liquid urea melt), preferably less than 0.5wt. %. In such embodiments, step (ii) preferably comprises a two-step evaporation process starting from a liquid aqueous composition comprising 65-75 wt. % (by total weight of the composition) urea and at least 20 wt. % (by total weight of the composition) water which is concentrated to 93-97 wt. % (by total weight of the composition) urea in a first evaporation stage using a first temperature-pressure combination, and subsequently concentrated to more than 99 wt. % (by total weight of the composition) urea in a second evaporation stage using a second temperature-pressure combination.

The solidification section of step (iii) preferably comprises a solidification apparatus selected from a prilling tower, a pelletizer, a fluidized bed granulator, a drum granulator, a falling curtain granulator, a spray dryer, a pan granulator, an extruder, a rotoformer, an oil priller and a compactor. More preferably, the solidification section of step (iii) preferably comprises a solidification apparatus selected from a prill tower, a rotoformer, a drum granulator and a fluidized bed granulator. In case the solidification apparatus is a prill tower or a rotoformer, step (ii) preferably comprises concentrating the aqueous composition obtained in step (i) to obtain a liquid urea melt having a water content of less than 1 wt. % (by total weight of the liquid urea melt), preferably less than 0.5 wt. % (by total weight of the liquid urea melt). This is preferably done using the two-step evaporation process described in the previous paragraph. In case the solidification apparatus is a drum granulator and/or a fluidized bed granulator, higher moisture levels are tolerated, such that the water content of less than 5 wt. % (by total weight of the composition) prescribed by step (ii) is generally sufficient. Preferably, step (ii) comprises concentrating the aqueous composition obtained in step (i) to obtain a liquid urea melt having a water content of less than 4 wt. % (by total weight of the composition), preferably less than 3 wt. % (by total weight of the composition).

As the present process allows retrofitting existing urea plants, the solid nitrogen fertilizer produced in step (iii) will typically be a regular urea fertilizer. Hence, in accordance with highly preferred embodiments of the invention, the particulate solid produced in step (iii) comprises more than 95 wt. % (by dry weight of the solid nitrogen fertilizer) urea, preferably comprises more than 98 wt. % (by dry weight of the solid nitrogen fertilizer) urea. The amount of biuret is preferably less than 2 wt. % (by dry weight of the solid nitrogen fertilizer), more preferably less than 1.5 wt. % (by dry weight of the solid nitrogen fertilizer), more preferably less than 1.2 wt. % (by dry weight of the solid nitrogen fertilizer), such as less than 1.0 wt. % (by dry weight of the solid nitrogen fertilizer). In some embodiments the amount of biuret is less than 0.5 wt. % (by dry weight of the solid nitrogen fertilizer) such that the urea is suitable for foliar use. Typically 0.3-0.4 wt. % formaldehyde will be present as anticaking agent, along with ammonia (typically <500 ppm) and other impurities.

Any solidification apparatus used in the solidification section of step (iii) will produce urea dust during normal operation which, if not treated, causes urea emissions in the surrounding atmosphere. Most solidification sections will by default collect the gas (typically air, also referred to as “solidifying gas”) which is used for cooling and solidifying the urea melt of step (ii) in order to submit the gas to treatment to at least reduce its ammonia content before it is vented to the atmosphere. Even in case of solidification apparatuses which do not explicitly rely on a forced solidifying gas stream, such as pan granulators or rotoformers, the ambient air has high urea dust and/or ammonia levels, which can be recovered from the solidification section using regular ventilation means. Most large-scale urea production facilities use a prilling tower or fluidized bed granulator which have dedicated air in-and outlets in order to actively force air flow. Since these plants already have a dedicated gas stream recovery from the solidification apparatus, the inventors have found that the method of the present invention is particularly preferred wherein step (iii) is performed in a prilling tower or fluidized bed granulator.

The present inventors have also found that in view of the valorisation of urea dust provided by the present invention, there is no need to minimize dust formation from an environmental point of view (although some measures may still be desirable in view of fouling of process equipment). This has the additional advantage that the solid nitrogen fertilizer produced in step (iii) can be produced substantially free of urea-formaldehyde, which allows the urea to be used for other purposes, in particular as AdBlue® ingredient. Urea-formaldehyde is used as an antidusting agent to minimize dust formation during solidification but renders the urea unsuitable for certain other uses, such as AdBlue® ingredient. Hence, in preferred embodiments of the present invention the method described herein is provided wherein the urea melt of step (ii) is substantially free of urea-formaldehyde, preferably free of any antidusting agent.

The recovery in step (iv) of urea from the gas stream of step (iii) to obtain a urea recyclate may be performed using any solid-gas separation means suitable for separating urea dust from the gas stream. In accordance with preferred embodiments of the invention, the amount of urea recovered in step (iv) is within the range of 0.5-5% of the urea fed to the solidification section of step (iii), preferably within the range of 2-5%. In case the method is operated as a continuous process, the amount of urea recovered in step (iv) within a predetermined timeframe is within the range of 0.5-5% of the urea fed to the solidification section of step (iii) in the same timeframe, preferably within the range of 2-5%. The urea recyclate is preferably a liquid aqueous composition comprising urea.

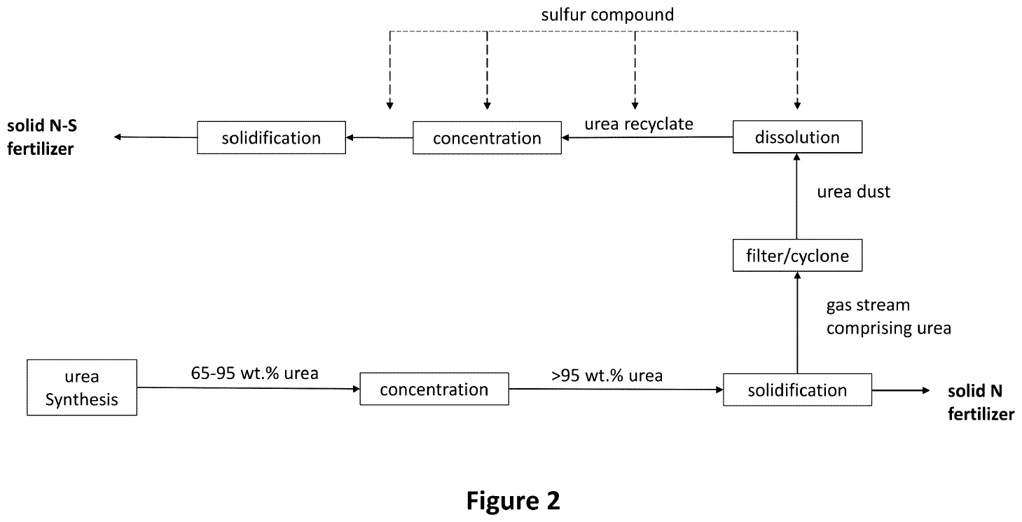

In a preferred embodiment of the invention, step (iv) is performed using cyclones and/or filters to obtain urea dust, and optionally contacting said urea dust with an aqueous phase. In such embodiments, the urea recyclate is preferably obtained in the form of an aqueous composition comprising at least 20 wt. % (by total weight of the composition) urea and at least 30 wt. % (by total weight of the composition) water, preferably in the form of an aqueous composition comprising 20-45 wt. % (by total weight of the composition) urea and 55-80 wt. % (by total weight of the composition) water. FIG. 2 illustrates an embodiment of the invention wherein step (iv) is performed using cyclones and/or filters to obtain urea dust, and said urea dust is dissolved in an aqueous phase.

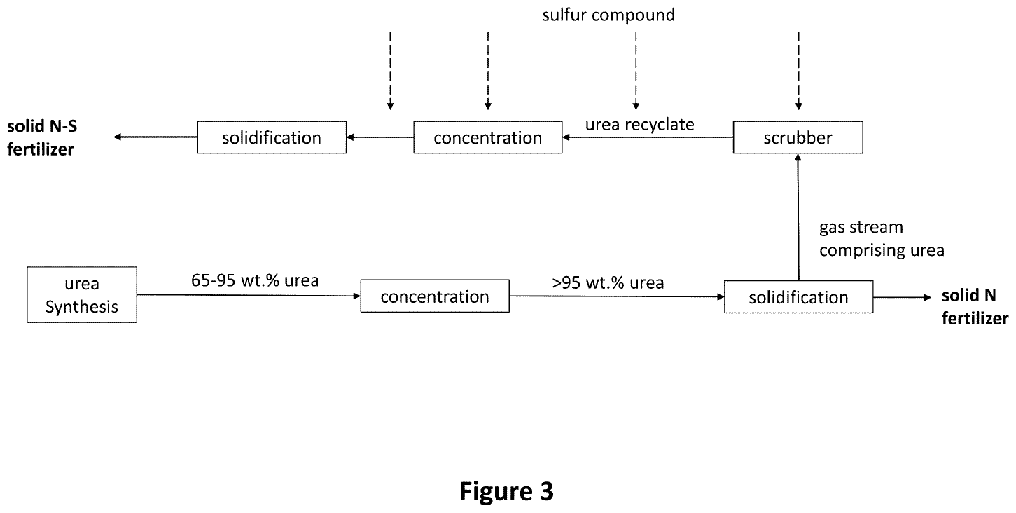

In an alternative, and more preferred embodiment of the invention, step (iv) is performed by means of a scrubber wherein the gas stream is contacted with an aqueous phase. In such embodiments the urea recyclate is preferably obtained in the form of an aqueous composition comprising at least 25 wt. % (by total weight of the composition) urea and at least 30 wt. % (by total weight of the composition) water, preferably in the form of an aqueous composition comprising at least 25-45 wt. % (by total weight of the composition) urea and 55-75 wt. % (by total weight of the composition) water. A scrubber is also interchangeably referred to herein as an “absorber”, which is equipment that permits rapid, intimate contact of gaseous process stream(s) and an aqueous medium, for example, a falling-film column, a packed column, a bubble column, a spray-tower, a gas-liquid agitated vessel, a plate column, a rotating disc contactor, a venturi tube, etc. The functioning of such absorbers is known to the skilled person, and in the case of vertical absorbers (e.g. columns, spray-towers) typically involves introducing one or more gas streams at the bottom part of the absorber, and introducing an aqueous phase at the top part of the absorber, such that the gas and the aqueous phase react in counter-current. The aqueous phase accumulates in the bottom part, where a level meter may monitor the liquid level and activate a pump to safeguard a maximum liquid level. FIG. 3 illustrates an embodiment of the invention wherein step (iv) is performed by means of a scrubber.

In some embodiments of the invention, the aqueous phase fed to the scrubber comprises an acid, such as oxalic acid, hydrochloric acid, sulphuric acid and/or nitric acid, preferably sulphuric acid and/or nitric acid, more preferably sulphuric acid, such that the urea recyclate obtained from the scrubber further comprises an ammonium compound selected from ammonium oxalate, ammonium chloride, ammonium sulphate, ammonium nitrate, and combinations thereof, preferably selected from ammonium sulphate, ammonium nitrate, and combinations thereof, preferably selected form ammonium sulphate. This ammonium compound will be comprised in the final nitrogen-sulfur fertilizer next to at least urea and the sulfur compound of step (v). In this way, for example a solid nitrogen-sulfur fertilizer which is a combined urea-thiosulphate-sulphate/nitrate/chloride/oxalate product can be produced. As is evident from the preferred embodiments outlined above, the use of hydrochloric acid and associated production of ammonium chloride is significantly less preferred than the use of oxalic acid, sulphuric or nitric acid and associated production of ammonium sulphate or nitrate, since chloride stress leads to corrosion issues in urea production plants. The use of oxalic acid or sulphuric acid and associated production of ammonium oxalate or sulphate is more preferred, with ammonium sulphate being most preferred.

However, it is highly preferred that the aqueous phase fed to the scrubber is substantially free of acid, in particular substantially free of oxalic acid, sulphuric acid, hydrochloric acid and nitric acid, such that an urea recyclate which is substantially free of ammonium compound selected from ammonium oxalate, ammonium chloride, ammonium sulphate, ammonium nitrate, and combinations thereof is obtained. This allows for maximum flexibility in adjusting the composition of the final nitrogen-sulfur fertilizer obtained in step (vii). For example, in some embodiments of the invention, no ammonium compound selected from ammonium oxalate, ammonium chloride, ammonium sulphate, ammonium nitrate, and combinations thereof is added to the urea recyclate stream such that the final nitrogen-sulfur fertilizer obtained in step (vii) is substantially free of ammonium compound selected from ammonium oxalate, ammonium chloride, ammonium sulphate, ammonium nitrate, and combinations thereof. In other embodiments of the invention, the final nitrogen-sulfur fertilizer does comprise ammonium compound selected from ammonium oxalate, ammonium chloride, ammonium sulphate, ammonium nitrate, and combinations thereof, but by obtaining an urea recyclate which is substantially free of ammonium compound selected from ammonium oxalate, ammonium chloride, ammonium sulphate, ammonium nitrate, and combinations thereof from the scrubber, the concentration of ammonium compound can easily be controlled.

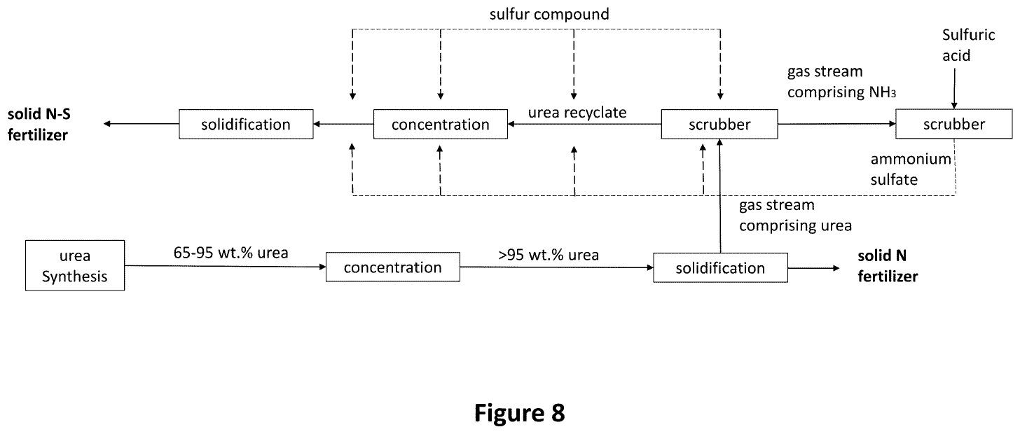

Accordingly, in some embodiments of the invention, step (iv) comprises contacting in a first scrubber the gas stream of step (iii) with an aqueous phase which is substantially free of acid, in particular substantially free of oxalic acid, hydrochloric acid, sulphuric acid and/or nitric acid such that an urea recyclate which is substantially free of ammonium compound selected from ammonium oxalate, ammonium chloride, ammonium sulphate and ammonium nitrate is obtained; recovering the off-gas from the first scrubber and contacting the off-gas from the first scrubber in a second scrubber with an aqueous phase comprising oxalic acid, hydrochloric acid, sulphuric acid and/or nitric acid, preferably sulphuric acid and/or nitric acid, more preferably sulphuric acid, such that an aqueous ammonium compound stream is obtained. The ammonium compound stream can then either be used for other purposes or, as in some preferred embodiments of the invention, at least part of the ammonium compound stream is combined with the urea recyclate before the solidification of step (vii) and before, during and/or after combining the urea recyclate with the sulfur compound of step (v), such that the final nitrogen-sulfur fertilizer comprises an ammonium compound selected from ammonium oxalate, ammonium chloride, ammonium sulphate, ammonium nitrate, and combinations thereof, preferably ammonium sulphate next to at least urea and the sulfur compound of step (v). FIG. 8 illustrates an embodiment of the invention wherein step (iv) comprises contacting in a first scrubber the gas stream of step (iii) with an aqueous phase which is substantially free of acid, in particular substantially free of oxalic acid, hydrochloric acid, sulphuric acid and/or nitric acid such that an urea recyclate which is substantially free of ammonium compound selected from ammonium oxalate, ammonium chloride, ammonium sulphate, ammonium nitrate, and combinations thereof is obtained; recovering the off-gas from the first scrubber and contacting the off-gas from the first scrubber in a second scrubber with an aqueous phase comprising sulphuric acid, such that an aqueous ammonium sulfate stream is obtained. In the embodiment of FIG. 8, it is further illustrated that this aqueous ammonium sulfate stream can be combined with the urea recyclate stream in the desired amount, showing a non-limiting number of example points of the process where the ammonium sulfate can be introduced.

In preferred embodiments of the invention, the sulfur compound provided in step (v) is selected from the group consisting of alkali metal salts, alkaline earth metal salts, iron salts, ammonium salts and combinations thereof, more preferably the sulfur compound provided in step (v) is selected from the group consisting of calcium salts, magnesium salts, potassium salts, ammonium salts, manganese salts, iron salts, ammonium salts and combinations thereof, more preferably the sulfur compound provided in step (v) is selected from the group consisting of potassium salts, calcium salts, ammonium salts and combinations thereof, most preferably the sulfur compound provided in step (v) is an ammonium salt. In preferred embodiments of the invention, the sulfur compound provided in step (v) is a thiosulphate salt. Hence, it follows that accordance with particularly preferred embodiments of the invention, the sulfur compound provided in step (v) is selected from the group consisting of alkali metal thiosulphates, alkaline earth metal thiosulphates, iron thiosulphates, ammonium thiosulphates and combinations thereof, more preferably the sulfur compound provided in step (v) is selected from the group consisting of calcium thiosulphates, magnesium thiosulphates, potassium thiosulphates, ammonium thiosulphates, manganese thiosulphates, iron thiosulphates, ammonium thiosulphates and combinations thereof, more preferably the sulfur compound provided in step (v) is selected from the group consisting of potassium thiosulphates, calcium thiosulphates, ammonium thiosulphates and combinations thereof, most preferably the sulfur compound provided in step (v) is ammonium thiosulphate.

The composition comprising the sulfur compound of step (v) may be provided as a solid, liquid or slurry. In some embodiments of the invention, the composition provided in step (v) is provided in the form of a solid, preferably in the form of a solid comprising more than 90 wt. % (by total weight of the solid) of the sulfur compound, more preferably in the form of a solid comprising more than 90 wt. % (by total weight of the solid) of the sulfur compound and having a water content of less than 5 wt. % (by total weight of the solid), more preferably in the form of a solid comprising more than 90 wt. % (by total weight of the solid) of the sulfur compound and having a water content of less than 3 wt. % (by total weight of the solid).

In alternative, highly preferred embodiments of the invention, the composition provided in step (v) is provided in the form of an aqueous solution of the sulfur compound, preferably in the form of an aqueous solution of the sulfur compound comprising at least 15 wt. % (by total weight of the aqueous solution provided in step (v)) of the sulfur compound, preferably at least 30 wt. % (by total weight of the aqueous solution provided in step (v)) of the sulfur compound. In preferred embodiments of the invention, the sulfur compound provided in step (v) is a thiosulphate and the composition provided in step (v) is provided in the form of an aqueous solution comprising:
ammonium thiosulfate in an amount resulting in a nitrogen content (as ammoniacal nitrogen) of more than 10 wt. % (by total weight of the aqueous solution provided in step (v)) and a sulfur content of more than 24 wt. % (by total weight of the aqueous solution provided in step (v)); or
potassium thiosulfate in an amount resulting in a potassium content (as K₂O) of more than 22 wt. % (by total weight of the aqueous solution provided in step (v)) and a sulfur content of more than 15 wt. % (by total weight of the aqueous solution provided in step (v)); or
calcium thiosulfate in an amount resulting in a calcium content of more than 5 wt. % (by total weight of the aqueous solution provided in step (v)) and a sulfur content of more than 8 wt. % (by total weight of the aqueous solution provided in step (v)); or
magnesium thiosulfate in an amount resulting in a magnesium content of more than 3 wt. % (by total weight of the aqueous solution provided in step (v)) and a sulfur content of more than 8 wt. % (by total weight of the aqueous solution provided in step (v));
   preferably
ammonium thiosulfate in an amount resulting in a nitrogen content (as ammoniacal nitrogen) of more than 10 wt. % (by total weight of the aqueous solution provided in step (v)) and a sulfur content of more than 26 wt. % (by total weight of the aqueous solution provided in step (v)).
   Advantageously, the method of the present invention allows the solid nitrogen-sulfur fertilizer to be prepared from commercially available liquid fertilizers, for example starting from a liquid thiosulfate product which is produced and sold as such (e.g. Thio-Sul®, KTS®, CaTs or MagThio® available from Tessenderlo Group NV or its subsidiaries). Advantageously, these products which already contain high thiosulfate concentrations close to the solubility limit, can be used to conveniently add thiosulfate to the urea recyclate with minimal introduction of water, which needs to be evaporated before solidification.

The composition provided in step (v) can be combined with the urea recyclate at any point before, during and/or after concentration of the urea recyclate. Preferably, the composition provided in step (v) is combined with the urea recyclate at any point before or during, preferably before, concentration of the urea recyclate to obtain a concentrated nitrogen-sulfur stream. The dotted line on FIGS. 1-10 illustrates a non-limiting number of example points of the process where the sulfur compound provided in step (v) can be introduced, such as:
a) during step (iv), e.g. by using the composition provided in step (v) as (part or all of) the aqueous phase of a scrubber employed in step (iv), or by using the composition provided in step (v) as (part or all of) the aqueous phase used to dissolve urea dust recovered in step (iv) using cyclones and/or filters; and/or
b) after step (iv), but before concentrating the urea recyclate, e.g. by simple in-line mixing;
c) during concentrating the urea recyclate, e.g. by addition to an evaporator; and/or
d) after concentrating the urea recyclate but before the solidification step (vii), e.g. by simple in-line mixing before the solidification section; and/or
e) inside the solidification section of step (vii), e.g. by mixing inside the solidification apparatus.
   It will be understood by the skilled person that methods a)-d) result in a homogenous particulate solid, while method e) may provide a heterogenous particulate solid, such as a coated granule.
   In highly preferred embodiments of the invention, the composition provided in step (v) is provided in the form of an aqueous solution of the sulfur compound, as described herein earlier, and the composition provided in step (v) is combined with the urea recyclate before and/or during the step of concentrating the urea recyclate. This has the advantage that the water introduced by the composition provided in step (v) can be at least partially removed before the solidification step (vii).

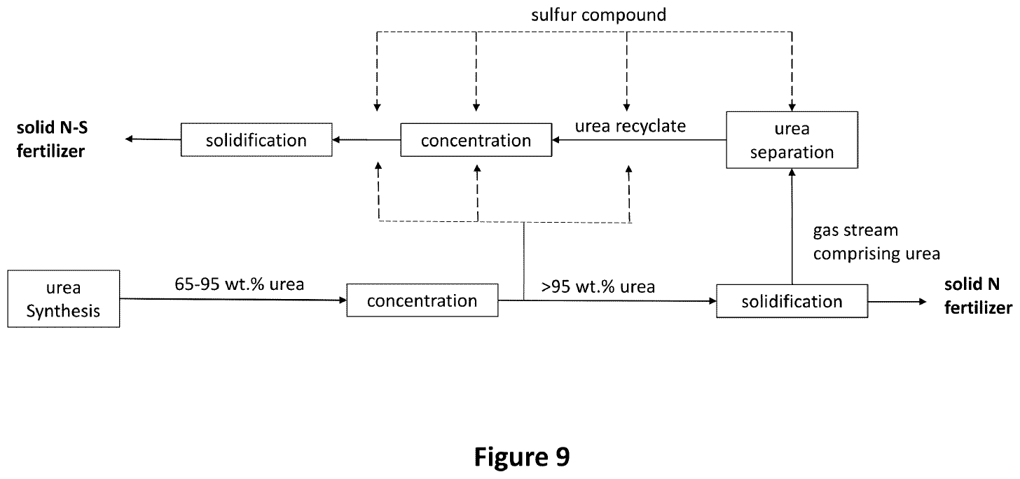

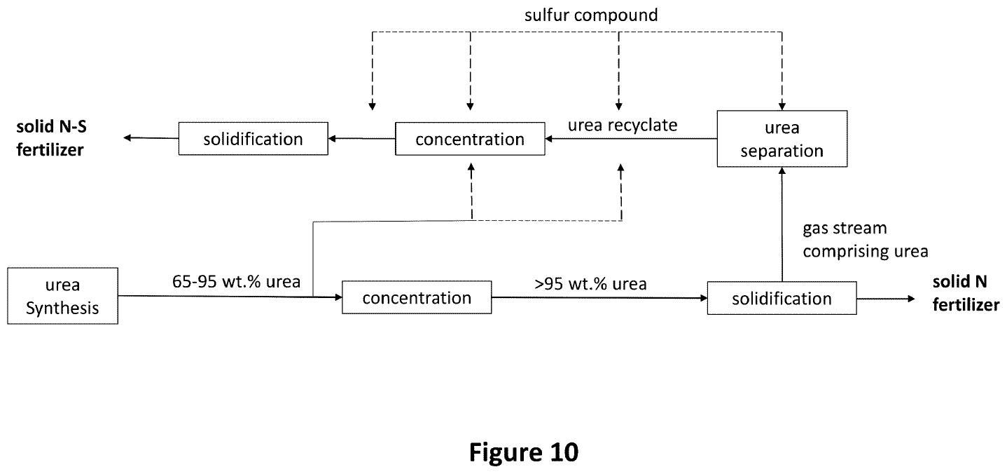

The present inventors have found that, depending on desired production volumes and process parameters, it can be advantageous to combine urea recyclate with the regular urea streams of step (i) and/or (ii). Such a processing scheme has the advantage that the production volumes of nitrogen-sulfur fertilizer can be increased beyond the amount of urea available from the recyclate stream. It also has as a further advantage that the water content of the urea recyclate stream (which may be relatively high, in particular in case scrubbers are used as explained herein elsewhere) can be reduced by adding more concentrated urea before the urea recyclate is fed to the evaporator. A bleed stream of regular urea streams of step (i) and/or (ii) can be used such that solid nitrogen fertilizer production can also concurrently take place. Hence, in accordance with preferred embodiments of the invention, the method for the production of a solid nitrogen fertilizer and a solid nitrogen-sulfur fertilizer as described herein further comprises combining the urea recyclate of step (iv) with part of the liquid aqueous composition comprising urea of step (i) and/or part of the liquid urea melt of step (ii), before, during and/or after the concentration step (vi). It is preferred that the liquid aqueous composition comprising urea of step (i) and/or the liquid urea melt of step (ii) is split into at least two streams, wherein a is used for the production of solid nitrogen fertilizer according to step (iii), and another stream is used for the production of solid nitrogen-sulfur fertilizer by combination with the urea recyclate of step (iv) before, during and/or after the concentration step (vi). In case the urea recyclate is combined with part of the liquid aqueous composition comprising urea of step (i), it is preferred that this takes place before, and/or during the concentration step (vi). This allows the water content introduced by the liquid aqueous composition comprising urea of step (i) to be largely removed before solidification step (vii). FIG. 9 illustrates an embodiment of the invention comprising combination of the urea recyclate of step (iv) with part of the liquid urea melt of step (ii), before, during and/or after the concentration step (vi). FIG. 10 illustrates an embodiment of the invention comprising combination of the urea recyclate of step (iv) with part of the liquid aqueous composition comprising urea of step (i), before, and/or during the concentration step (vi). It is explicitly envisaged that the embodiments of the process comprising combination of the recyclate with part of the regular urea streams of step (i) and/or (ii) (such as the embodiments of FIGS. 9 and 10), are combined with other embodiments of the invention described herein, such as in particular embodiments comprising recycling of the evaporation condensate obtained in step (vi) to step (iv) as described herein elsewhere, and/or embodiments comprising recovering from the solidification section of step (vii) a gas stream comprising urea and the sulfur compound, and combining said gas stream with the gas stream recovered from the solidification section of step (iii), as described herein elsewhere.

The present inventors have also found that, depending on desired production volumes and process parameters, it can be advantageous to combine urea recyclate with off-spec urea produced in the process of steps (i)-(iii). Hence, in some embodiments the methods of the invention comprise the steps of:
(a) defining one or more quality criteria for the solid nitrogen fertilizer of step (iii);
(b) determining compliance with at least one of the quality criteria for the solid nitrogen fertilizer produced in step (a), and selecting solid nitrogen fertilizer which does not comply with at least one of the quality criteria defined in step (a); and
(c) combining at least part of the solid nitrogen fertilizer selected in step (b) with the urea recyclate of step (iv) before, during and/or after the concentration step (vi).
   Preferably the quality criteria defined in step (a) comprises one or both of the following criteria:
a biuret level of less than 1.2 wt. % (by total weight of the solid nitrogen fertilizer);
a particle size within the range of 1-4 mm.
   A solid nitrogen fertilizer is considered non-compliant if it has a biuret level of more than 1.2 wt. % or a particle size outside the range of 1-4 mm. A preferred quality criterion is a particle size within the range of 1-4 mm as selection of non-compliant solid nitrogen fertilizer is easily performed by a screening operation.

The present inventors have also found that, depending on desired production volumes and process parameters, it can be advantageous to combine urea recyclate with solidification section wash water originating from maintenance of the solidification section, in particular of the solidification apparatus comprised in the solidification section. Hence, in some embodiments the methods of the invention comprise the step of combining solidification section wash water originating from maintenance of the solidification section with the urea recyclate of step (iv) before, during and/or after the concentration step (vi).

In accordance with preferred embodiments of the invention, concentration step (vi) is performed by evaporation. Concentration step (vi) may be performed as a single or multi-stage evaporation. The type of evaporator(s) employed is not particularly limiting, and may be for example selected from falling-film evaporators, rising film evaporators, thin-film evaporators, wiped film evaporators, short path evaporators, forced circulation evaporators, plate evaporators, plate and frame evaporators, shell-and-tube evaporators and combinations thereof. The evaporation of step (vi) is preferably performed using falling-film evaporation, wiped-film evaporation and combinations thereof. The evaporator(s) may be operated in known modes such as single or multiple pass, multiple-effect, employing thermal vapor recompression, employing mechanical vapor recompression, etc. It will be understood by the skilled person that if the urea recyclate is not provided in the form of an aqueous composition but as plain urea dust, it is necessary.
to provide the composition of step (v) in the form of an aqueous solution of the sulfur compound as described herein elsewhere, and to combine it with the urea recyclate of step (iv) at least in part before and/or during the concentration step (vi); and/or
to combine the urea recyclate of step (iv) with part of the liquid aqueous composition comprising urea of step (i), at least in part before and/or during the concentration step (vi).

In accordance with highly preferred embodiments of the invention, step (vi) comprises concentrating urea recyclate by evaporation and further comprises recycling at least part of the condensate to the urea recovery of step (iv). In such embodiments, the process of the present invention has the particular advantage that, since the sulfur-containing streams employ a dedicated evaporator, solid nitrogen-sulfur fertilizer as described herein can be produced without contamination of the urea synthesis plant by sulfur compounds of the present invention, elemental sulfur and/or other sulfur containing byproducts, and in particular without build-up in the urea synthesis plant of sulfur compounds of the present invention, elemental sulfur and/or other sulfur containing byproducts.

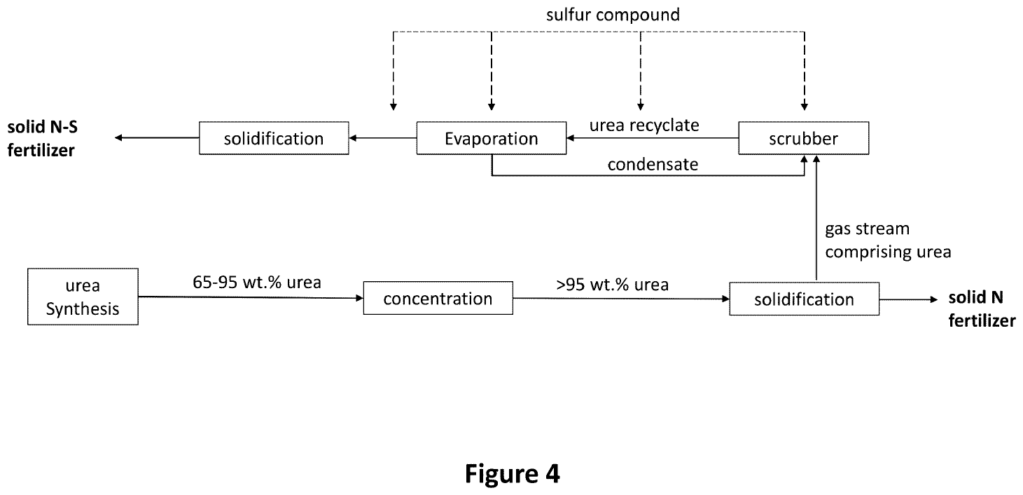

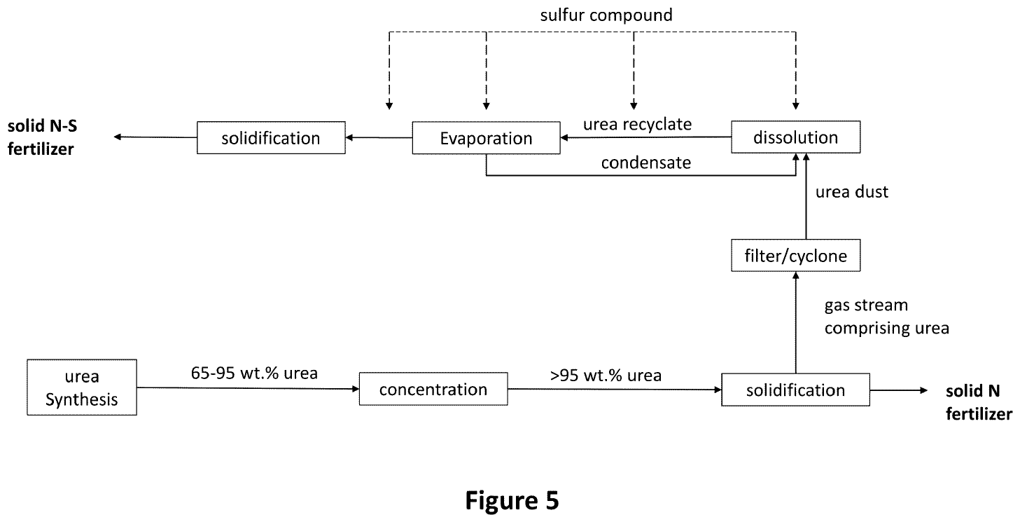

In particularly preferred embodiments of the invention, step (iv) comprises separating urea dust from the gas stream by means of a scrubber as described herein earlier; concentration step (vi) is performed by evaporation as described herein earlier; and at least part of the condensate from the evaporator is recirculated to the scrubber of step (iv) to form at least part of the aqueous phase fed to the scrubber. This embodiment is illustrated in FIG. 4. In alternative embodiments of the invention, step (iv) comprises recovering urea from the gas stream by means of cyclones and/or filters, thereby obtaining urea dust, and contacting said urea dust with an aqueous phase as described herein earlier; concentration step (vi) is performed by evaporation as described herein earlier; and at least part of the condensate from the evaporator is recirculated to step (iv) to form at least part of the aqueous phase used to dissolve the urea dust. This embodiment is illustrated in FIG. 5.

It is particularly preferred that the embodiments of the invention described herein elsewhere specifying recycling of non-converted reagents from a recovery section and recycling of evaporator condensate from the evaporator of step (ii) are combined with the recycling of condensate of the evaporator of step (vi) to the urea recovery of step (iv) as described in the previous paragraphs. In this way an optimized and efficient process can be obtained.

The extent of evaporation required in step (vi) is largely dependent on the maximum moisture content accepted by the solidification process employed by the solidification section of step (vii), and it is within the routine capabilities of the skilled person, based on the present disclosure, to optimize this. In accordance with highly preferred embodiments of the invention, the concentrated nitrogen-sulfur stream of step (vi) is an urea melt wherein the combined amount of urea and the sulfur compound comprised in the concentrated nitrogen-sulfur stream is at least 95 wt. % (by total weight of the concentrated nitrogen-sulfur stream), preferably at least 99 wt. % (by total weight of the concentrated nitrogen-sulfur stream). In some embodiments of the invention, step (vi) comprises concentrating the urea recyclate to obtain a concentrated nitrogen-sulfur stream which is an urea melt having a water content of less than 1 wt. % (by total weight of the concentrated nitrogen-sulfur stream), preferably less than 0.5 wt. % (by total weight of the concentrated nitrogen-sulfur stream).

In some embodiments of the invention, the temperature of the concentrated nitrogen-sulfur stream is more than 128° C. when exiting the evaporator, in order to avoid solidification of urea before the process stream enters the solidification section (e.g. when passing cold spots). In alternative and preferred embodiments of the invention, the evaporation of step (vi) is performed at a temperature of less than 128° C., preferably a temperature of equal to or less than 125° C., more preferably a temperature within the range of 100-125° C. In particular, a temperature within the range of 110-125° C. such as 110-120° C. is envisaged. This can be achieved by using a concentrated nitrogen-sulfur stream which comprises 30-90 wt. % (by dry weight of the nitrogen-sulfur stream) urea and 10-70 wt. % (by dry weight of the nitrogen-sulfur stream) of the sulfur compound, preferably by using a concentrated nitrogen-sulfur stream which comprises 70-90 wt. % (by dry weight of the nitrogen-sulfur stream) urea and 10-30 wt. % (by dry weight of the nitrogen-sulfur stream) of the sulfur compound. As is shown in the appended examples, the present inventors have found that at these urea: sulfur compound ratio's a significant melting point depression occurs, such that the evaporation temperature can be lowered without risk of solidifying the urea. Operating the evaporator at less than 128° C. has the advantage that less decomposition of the sulfur compound occurs, and energy costs can be reduced. Similarly, transport of the nitrogen-sulfur stream to the solidification section can occur at reduced temperatures without risk of solidifying the urea. Hence, it is preferred if the temperature of the concentrated nitrogen-sulfur stream is kept below 128° C. for substantially all of the process between the point of combining the composition provided in step (v) with the urea recyclate and the point where it is fed to the solidification apparatus employed in the solidification section of step (vii). The temperature is preferably kept equal to or below 125° C., more preferably within the range of 100-125° C. In particular, a temperature within the range of 110-125° C. such as 110-120° C. is envisaged. As is explained herein elsewhere, the point of combining the composition provided in step (v) with the urea recyclate may occur before, during and/or after the evaporation of step (vi). If it is done after the evaporation of step (vi), the evaporator will have to be operated above 128° C. to avoid solidification of urea in the evaporator, but the temperature during transport of the melt from the evaporator to the solidification section of step (vii) can be lowered to be below 128° C. as soon as the composition provided in step (v) is combined with the urea recyclate. Hence, in accordance with preferred embodiments there is provided the process of the present invention wherein the composition provided in step (v) is combined with the urea recyclate before evaporation in an amount such that the concentrated nitrogen-sulfur stream comprises 70-90 wt. % (by dry weight of the nitrogen-sulfur stream) urea and 10-30 wt. % (by dry weight of the nitrogen-sulfur stream) of the sulfur compound, wherein combining the composition provided in step (v) with the urea recyclate is preferably before the evaporation of step (vi), and wherein:
concentration step (vi) is performed by evaporation at a temperature of less than 128° C., preferably a temperature of equal to or less than 125° C., most preferably a temperature within the range of 100-125° C.; and/or.
the temperature of the concentrated nitrogen-sulfur stream is kept below 128° C. for substantially all of the process between the point of combining the composition provided in step (v) with the urea recyclate and the point where it is fed to the solidification apparatus comprised in the solidification section of step (vii), preferably equal to or below 125° C., more preferably within the range of 100-125° C.

The solidification apparatus comprised in the solidification section of step (vii) is preferably selected from a prilling tower, a pelletizer, a fluidized bed granulator, a drum granulator, a falling curtain granulator, a spray dryer, a pan granulator, an extruder, a rotoformer, an oil priller and a compactor. More preferably, the solidification apparatus comprised in the solidification section of step (vii) is selected from a prill tower, a rotoformer, a drum granulator and a fluidized bed granulator. In case the solidification apparatus is a prill tower or a rotoformer, step (vi) preferably comprises concentrating the urea recyclate to obtain a concentrated nitrogen-sulfur stream having a water content of less than 1 wt. % (by total weight of the concentrated nitrogen-sulfur stream), preferably less than 0.5 wt. % (by total weight of the concentrated nitrogen-sulfur stream). In case the solidification apparatus is a drum granulator and/or a fluidized bed granulator, higher moisture levels are tolerated, such that it is generally sufficient if step (vi) comprises concentrating the urea recyclate to obtain a concentrated nitrogen-sulfur stream having a water content of less than 5 wt. % (by total weight of the concentrated nitrogen-sulfur stream), preferably less than 4 wt. % (by total weight of the concentrated nitrogen-sulfur stream).

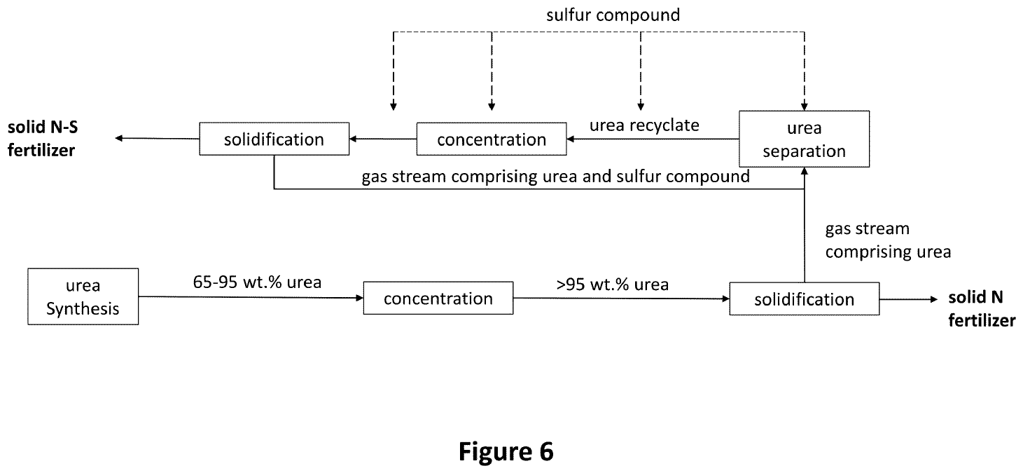

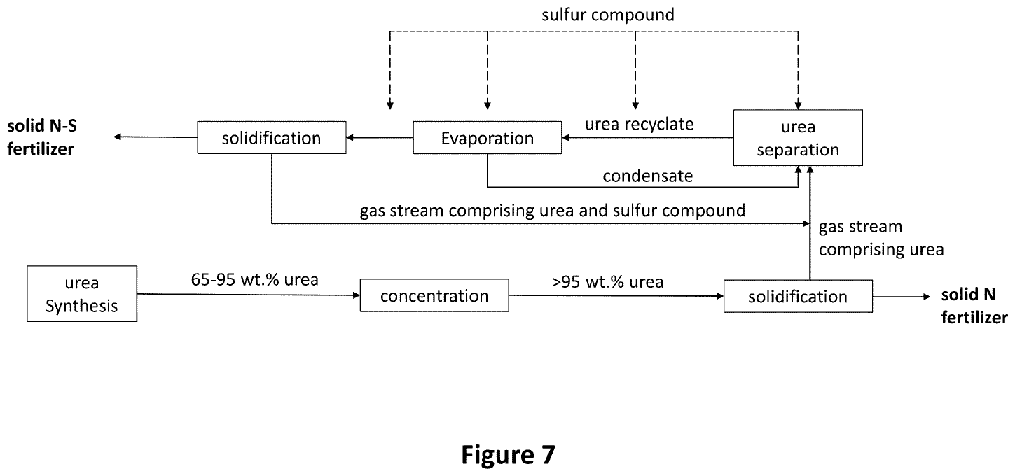

In preferred embodiments of the present invention, step (vii) comprises recovering from the solidification section a gas stream comprising urea and the sulfur compound, and combining said gas stream with the gas stream recovered from the solidification section of step (iii); and wherein step (iv) comprises recovering urea from the combined gas streams to obtain the urea recyclate. This embodiment is illustrated in FIG. 6. In more preferred embodiments of the present invention, step (vi) comprises concentrating urea recyclate by evaporation and further comprises recycling at least part of the condensate to the urea recovery of step (iv), and step (vii) comprises recovering from the solidification section a gas stream comprising urea and the sulfur compound, and combining said gas stream with the gas stream recovered from the solidification section of step (iii); and wherein step (iv) comprises recovering urea from the combined gas streams to obtain the urea recyclate. This embodiment is illustrated in FIG. 7.

The composition of step (v) may be combined with the urea recyclate in any ratio, depending on the desired properties of the final nitrogen-sulfur fertilizer. In accordance with embodiments of the invention, the composition provided in step (v) is combined with the urea recyclate in an amount such that the concentrated nitrogen-sulfur stream comprises 1-99 wt. % (by dry weight of the nitrogen-sulfur stream) urea and 1-99 wt. % (by dry weight of the concentrated nitrogen-sulfur stream) of the sulfur compound. In all embodiments according to the invention, it is preferred that the combined amount of urea, the sulfur compound, ammonium sulphate and ammonium nitrate comprised in the concentrated urea-thiosulphate stream of step (vi) is at least 95 wt. % (by dry weight of the concentrated nitrogen-sulfur stream), preferably at least 97 wt. % (by dry weight of the concentrated nitrogen-sulfur stream), more preferably at least 99 wt. % (by dry weight of the concentrated nitrogen-sulfur stream).

More preferably, the combined amount of urea and the sulfur compound comprised in the concentrated urea-thiosulphate stream of step (vi) is at least 95 wt. % (by dry weight of the concentrated nitrogen-sulfur stream), preferably at least 97 wt. % (by dry weight of the concentrated nitrogen-sulfur stream), more preferably at least 99 wt. % (by dry weight of the concentrated nitrogen-sulfur stream). As will be understood by the skilled person, this corresponds to embodiments wherein the concentrated urea-thiosulphate stream of step (vi) has a low amount of ammonium compound selected from ammonium sulfate and/or ammonium nitrate, or is even substantially free of ammonium compound selected from ammonium sulfate and/or ammonium nitrate. As is explained herein elsewhere, this can for example be achieved by methods of the present invention wherein step (iv) comprises contacting in a scrubber the gas stream of step (iii) with an aqueous phase which is substantially free of sulphuric acid and nitric acid such that an urea recyclate which is substantially free of ammonium compound selected from ammonium sulphate and/or ammonium nitrate is obtained.

In preferred embodiments of the invention, the composition provided in step (v) is combined with the urea recyclate in an amount such that the concentrated nitrogen-sulfur stream comprises 10-99 wt. % (by dry weight of the concentrated nitrogen-sulfur stream) urea and 1-90 wt. % (by dry weight of the concentrated nitrogen-sulfur stream) of the sulfur compound, preferably 50-95 wt. % (by dry weight of the concentrated nitrogen-sulfur stream) urea and 5-50 wt. % (by dry weight of the concentrated nitrogen-sulfur stream) sulfur compound, more preferably 70-90 wt. % (by dry weight of the concentrated nitrogen-sulfur stream) urea and 10-30 wt. % (by dry weight of the concentrated nitrogen-sulfur stream) sulfur compound, most preferably 75-85 wt. % (by dry weight of the concentrated nitrogen-sulfur stream) urea and 15-25 wt. % (by dry weight of the concentrated nitrogen-sulfur stream) sulfur compound. This most preferred composition is agronomically optimized for sulfur and nitrogen rates and ensures sufficient sulfur compound is present to exhibit a large nitrification and/or urease inhibition effect, while, as explained herein elsewhere, it also allows the evaporation step to be performed at milder conditions than is the case for regular urea processing thanks to the melting point depression observed at these urea: sulfur compound ratios.

In alternative embodiments of the invention, the composition provided in step (v) is combined with the urea recyclate in an amount such that the concentrated nitrogen-sulfur stream comprises 1-99 wt. % (by dry weight of the concentrated nitrogen-sulfur stream) of the sulfur compound and 1-90 wt. % (by dry weight of the concentrated nitrogen-sulfur stream) urea, preferably 50-95 wt. % (by dry weight of the concentrated nitrogen-sulfur stream) of the sulfur compound and 5-50 wt. % (by dry weight of the concentrated nitrogen-sulfur stream) urea, more preferably 70-90 wt. % (by dry weight of the concentrated nitrogen-sulfur stream) of the sulfur compound and 10-30 wt. % (by dry weight of the concentrated nitrogen-sulfur stream) urea, most preferably 75-85 wt. % (by dry weight of the concentrated nitrogen-sulfur stream) of the sulfur compound and 15-25 wt. % (by dry weight of the concentrated nitrogen-sulfur stream) urea.

As will be understood by the skilled person, the method of the present invention enables the simultaneous coproduction of urea fertilizer and urea-sulfur compound (e.g. urea-thiosulfate) fertilizer. Hence, in accordance with preferred embodiments of the invention the method is provided for the simultaneous coproduction of a solid nitrogen fertilizer and a solid nitrogen-sulfur fertilizer. Preferably, the method is provided for the simultaneous coproduction of a solid nitrogen fertilizer and a solid nitrogen-sulfur fertilizer wherein steps (ii) and (iii) are performed simultaneously with steps (vi) and (vii), wherein
step (ii) comprises concentrating the liquid composition of step (i) in a first evaporator as described herein;
step (vi) comprises concentrating the urea recyclate of step (iv) in a second evaporator as described herein, wherein the second evaporator employed in step (vi) is a distinct apparatus from the first evaporator employed in step (ii); and
step (iii) is performed in a first solidification apparatus and step (vii) is performed employing a second solidification apparatus distinct from the first solidification apparatus of step (iii).

This embodiment has the advantage that a large production capacity is available and cross-contamination is avoided, but requires investment in two separate production lines since the evaporator and solidification apparatus employed for the solid nitrogen fertilizer are distinct from the evaporator and solidification apparatus employed for the solid nitrogen-sulfur fertilizer. The first and second solidification apparatus may be the same type of apparatus (e.g. a first and second fluidized bed granulator), provided they are distinct units such that e.g. cross-contamination is avoided and simultaneous coproduction is enabled.

As will be understood by the skilled person, the method of the present invention also enables the alternate production of urea fertilizer and urea-sulfur compound (e.g. urea-thiosulfate) fertilizer. Hence, in accordance with preferred embodiments of the invention the method is provided for the alternate production of a solid nitrogen fertilizer and a solid nitrogen-sulfur fertilizer. Preferably, the method is provided for the alternate production of a solid nitrogen fertilizer and a solid nitrogen-sulfur fertilizer wherein step (iii) is performed during a first period, and step (vii) is performed during a subsequent second period, wherein
step (ii) comprises concentrating the liquid composition of step (i) in an evaporator as described herein;
step (vi) comprises concentrating the urea recyclate of step (iv) in an evaporator as described herein, wherein the evaporator employed in step (vi) is preferably a distinct apparatus from the evaporator employed in step (ii);
step (vi) may be performed during the first and/or the second period, wherein if step (vi) is performed at least in part during the first period, the second evaporator employed in step (vi) is a distinct apparatus from the first evaporator employed in step (ii); and
step (iii) is performed in solidification apparatus and step (vii) is performed employing the same solidification apparatus as step (iii).
   At least part of the urea recyclate obtained in step (iv) is stored during the first period for utilization in the second period.
   This embodiment has the advantage that solid nitrogen-sulfur fertilizer can be produced without the need for the investment in a separate solidification apparatus, but requires storage of the urea recyclate until nitrogen-sulfur fertilizer production begins.

In some embodiments, step (vii) of the method of the present invention further comprises submitting the solid nitrogen-sulfur fertilizer to a drying step. The present inventors have found that this may be useful to eliminate trace moisture from the solid nitrogen-sulfur fertilizer.

The method of the present invention may be operated in batch, semi-continuous or continuous mode, but is preferably operated in continuous mode.

As is explained herein earlier, particular embodiments of the method of the invention result in a solid nitrogen-sulfur fertilizer comprising urea, the sulfur compound and further comprising ammonium sulfate and/or ammonium nitrate. This is in particular the case for the method of the invention wherein step (iv) is performed by means of a scrubber wherein the gas stream of step (iii) is contacted with an aqueous wherein
(a) the aqueous phase fed to the scrubber comprises sulphuric acid and/or nitric acid, such that the urea recyclate obtained from the scrubber further comprises an ammonium compound selected from ammonium sulphate and/or ammonium nitrate; or
(b) step (iv) comprises contacting in a first scrubber the gas stream of step (iii) with an aqueous phase which is substantially free of sulphuric acid and/or nitric acid such that an urea recyclate which is substantially free of ammonium compound selected from ammonium sulphate and/or ammonium nitrate is obtained; recovering the off-gas from the first scrubber and contacting the off-gas from the first scrubber in a second scrubber with an aqueous phase comprising sulphuric acid and/or nitric acid, such that an aqueous ammonium compound stream is obtained, wherein at least at least part of the ammonium compound stream is combined with the urea recyclate before the solidification of step (vii) and before, during and/or after combining the urea recyclate with the sulfur of step (v).
   In such embodiments of the method of the invention, in particular when the method is according to (b), it is particularly preferred that the urea, the sulfur compound and the ammonium compound are combined at ratios such that the solid nitrogen-sulfur fertilizer obtained in step (vii) comprises at least 50 wt. % urea (by total weight of the solid nitrogen-sulfur fertilizer), at least 10 wt. % (by total weight of the solid nitrogen-sulfur fertilizer) of the sulfur compound, 5-35 wt. % (by total weight of the solid nitrogen-sulfur fertilizer) of the ammonium compound, and less than 5 wt. % (by total weight of the solid nitrogen-sulfur fertilizer) water. Preferably, the solid nitrogen-sulfur fertilizer obtained in step (vii) comprises less than 2 wt. % (by total weight of the solid nitrogen-sulfur fertilizer) water, preferably less than 1 wt. % (by total weight of the solid nitrogen-sulfur fertilizer) water, most preferably less than 1 wt. % (by total weight of the solid nitrogen-sulfur fertilizer) water. More preferably the solid nitrogen-sulfur fertilizer obtained in step (vii) comprises at least 70 wt. % urea (by total weight of the solid nitrogen-sulfur fertilizer), 10-25 wt. % (by total weight of the solid nitrogen-sulfur fertilizer) of the sulfur compound, 5-20 wt. % (by total weight of the solid nitrogen-sulfur fertilizer) of the ammonium compound, and less than 1 wt. % (by total weight of the solid nitrogen-sulfur fertilizer) water, preferably less than 0.5 wt. % (by total weight of the solid nitrogen-sulfur fertilizer) water.

In another aspect of the invention there is provided the solid nitrogen-sulfur fertilizer obtainable by the method of the invention wherein step (iv) is performed by means of a scrubber wherein the gas stream of step (iii) is contacted with an aqueous wherein
(a) the aqueous phase fed to the scrubber comprises sulphuric acid and/or nitric acid, such that the urea recyclate obtained from the scrubber further comprises an ammonium compound selected from ammonium sulphate and/or ammonium nitrate; or
(b) step (iv) comprises contacting in a first scrubber the gas stream of step (iii) with an aqueous phase which is substantially free of sulphuric acid and/or nitric acid such that an urea recyclate which is substantially free of ammonium compound selected from ammonium sulphate and/or ammonium nitrate is obtained; recovering the off-gas from the first scrubber and contacting the off-gas from the first scrubber in a second scrubber with an aqueous phase comprising sulphuric acid and/or nitric acid, such that an aqueous ammonium compound stream is obtained, wherein at least at least part of the ammonium compound stream is combined with the urea recyclate before the solidification of step (vii) and before, during and/or after combining the urea recyclate with the sulfur of step (v).
   In such embodiments of the method of the invention, in particular when the method is according to (b), it is particularly preferred that the urea, the sulfur compound and the ammonium compound are combined at ratios such that the solid nitrogen-sulfur fertilizer obtained in step (vii) comprises at least 50 wt. % urea (by total weight of the solid nitrogen-sulfur fertilizer), at least 10 wt. % (by total weight of the solid nitrogen-sulfur fertilizer) of the sulfur compound, 5-35 wt. % (by total weight of the solid nitrogen-sulfur fertilizer) of the ammonium compound, and less than 5 wt. % (by total weight of the solid nitrogen-sulfur fertilizer) water. Preferably, the solid nitrogen-sulfur fertilizer obtained in step (vii) comprises less than 2 wt. % (by total weight of the solid nitrogen-sulfur fertilizer) water, preferably less than 1 wt. % (by total weight of the solid nitrogen-sulfur fertilizer) water, most preferably less than 1 wt. % (by total weight of the solid nitrogen-sulfur fertilizer) water. More preferably the solid nitrogen-sulfur fertilizer obtained in step (vii) comprises at least 70 wt. % urea (by total weight of the solid nitrogen-sulfur fertilizer), 10-25 wt. % (by total weight of the solid nitrogen-sulfur fertilizer) of the sulfur compound, 5-20 wt. % (by total weight of the solid nitrogen-sulfur fertilizer) of the ammonium compound, and less than 1 wt. % (by total weight of the solid nitrogen-sulfur fertilizer) water, preferably less than 0.5 wt. % (by total weight of the solid nitrogen-sulfur fertilizer) water.

In all embodiments of the method described herein, it is preferred that the solid nitrogen-sulfur fertilizer comprises urea and the sulfur compound provided in step (v) in an amount such that the ratio (w/w) of “N from urea” to “S from the sulfur compound” is at most about 8:1, preferably at most about 7.5:1, more preferably at most about 7:1, and at least about 1.1:1, preferably at least about 1.5:1, more preferably at least about 2:1, wherein N refers to the total amount of nitrogen (N) from urea in the solid nitrogen-sulfur fertilizer, and S refers to the total amount of sulfur (S) from the sulfur compound in the solid nitrogen-sulfur fertilizer.

In another aspect of the invention there is provided a solid composition, preferably a solid fertilizer, comprising urea, a sulfur compound selected from the group consisting of thiosulphate salts, (bi)sulfite salts, polysulfide salts, (bi)sulfide salts, metabisulfite salts, dithionite salts, elemental sulfur and combinations thereof, preferably selected from the group consisting of thiosulphate salts, (bi)sulfite salts, polysulfide salts and combinations thereof and an ammonium compound selected from ammonium sulphate and/or ammonium nitrate, and less than 5 wt. % (by total weight of the composition) water. Preferably, the combined amount of the urea, the sulfur compound, and the ammonium compound is at least 95 wt. % (by dry weight of the solid composition), preferably at least 97 wt. % (by dry weight of the solid composition), more preferably at least 99 wt. % (by dry weight of the solid composition).

In preferred embodiments the solid composition of the invention comprises at least 50 wt. % urea (by total weight of the composition), at least 10 wt. % (by total weight of the composition) of a sulfur compound selected from the group consisting of thiosulphate salts, (bi)sulfite salts, polysulfide salts, (bi)sulfide salts, metabisulfite salts, dithionite salts, elemental sulfur and combinations thereof, preferably selected from the group consisting of thiosulphate salts, (bi)sulfite salts, polysulfide salts and combinations thereof, 5-35 wt. % (by total weight of the composition) of an ammonium compound selected from ammonium sulphate and/or ammonium nitrate, and less than 5 wt. % (by total weight of the composition) water. Preferably the composition comprises less than 1 wt. % (by total weight of the composition) water, preferably less than 0.5 wt. % (by total weight of the composition) water. More preferably the composition comprises at least 70 wt. % urea (by total weight of the composition), at least 10-25 wt. % (by total weight of the composition) of a sulfur compound selected from the group consisting of thiosulphate salts, (bi)sulfite salts and/or polysulfide salts, 5-20 wt. % (by total weight of the composition) of an ammonium compound selected from ammonium sulphate and/or ammonium nitrate, and less than 1 wt. % (by total weight of the composition) water, preferably less than 0.5 wt. % (by total weight of the composition) water.

In preferred embodiments of the composition of the invention, the sulfur compound is selected from the group consisting of alkali metal salts, alkaline earth metal salts, iron salts, ammonium salts and combinations thereof, more preferably the sulfur compound is selected from the group consisting of calcium salts, magnesium salts, potassium salts, ammonium salts, manganese salts, iron salts, ammonium salts and combinations thereof, more preferably the sulfur compound is selected from the group consisting of potassium salts, calcium salts, ammonium salts and combinations thereof, most preferably the sulfur compound is an ammonium salt. In preferred embodiments of the invention, the sulfur compound is a thiosulphate salt. Hence, it follows that accordance with particularly preferred embodiments of the invention, the sulfur compound is selected from the group consisting of alkali metal thiosulphates, alkaline earth metal thiosulphates, iron thiosulphates, ammonium thiosulphates and combinations thereof, more preferably the sulfur compound is selected from the group consisting of calcium thiosulphates, magnesium thiosulphates, potassium thiosulphates, ammonium thiosulphates, manganese thiosulphates, iron thiosulphates, ammonium thiosulphates and combinations thereof, more preferably the sulfur compound is selected from the group consisting of potassium thiosulphates, calcium thiosulphates, ammonium thiosulphates and combinations thereof, most preferably the sulfur compound is ammonium thiosulphate.

In preferred embodiments the composition of the invention is a single particle of a particulate solid, preferably a homogeneous single particle, more preferably a homogenous granule, prill, pellet or pastille.

In all embodiments of the composition of the invention described herein, it is preferred that the urea and the sulfur compound are present in an amount such that the ratio (w/w) of “N from urea” to “S from the sulfur compound” is at most about 8:1, preferably at most about 7.5:1, more preferably at most about 7:1, and at least about 1.1:1, preferably at least about 1.5:1, more preferably at least about 2:1, wherein N refers to the total amount of nitrogen (N) from urea in the solid composition, and S refers to the total amount of sulfur(S) from the sulfur compound in the solid composition.

As is common in the art, the process stream(s) fed to the solidification section of step (iii) and/or step (vii) in the methods of the invention described herein, as well as the solid compositions of the invention may comprise optional additives such as but not limited to dyes, colorants, odor masking agents, flow aids, processing aids (such as, for example, a granulating binder), conditioning agents (like e.g. mineral oil), anti-caking agents (such as, for example, lime, gypsum, silicon dioxide, kaolinite and/or PVA), hardening agents, surfactants, silicas, thickeners, viscosity modifiers, pH control agents, buffers, copper, molybdenum, elemental sulfur, bactericides, urease and/or nitrification inhibitors (e.g. N-(n-butyl)thiophosphoric triamide (NBPT), dicyandiamide (DCD), etc.).

In another aspect there is provided the use of the solid composition of the invention as a fertilizer.

### EXAMPLES

### Example 1

### Melting Point Depression of Urea-Ammonium Thiosulfate Blends

An ammonium thiosulfate solution (Thio-Sul® from Tessenderlo Kerley) was freeze dried to obtain solid ammonium thiosulfate, which was examined by Differential Scanning calorimetry. The melting point of solid ammonium thiosulfate was determined to be about 134° C.

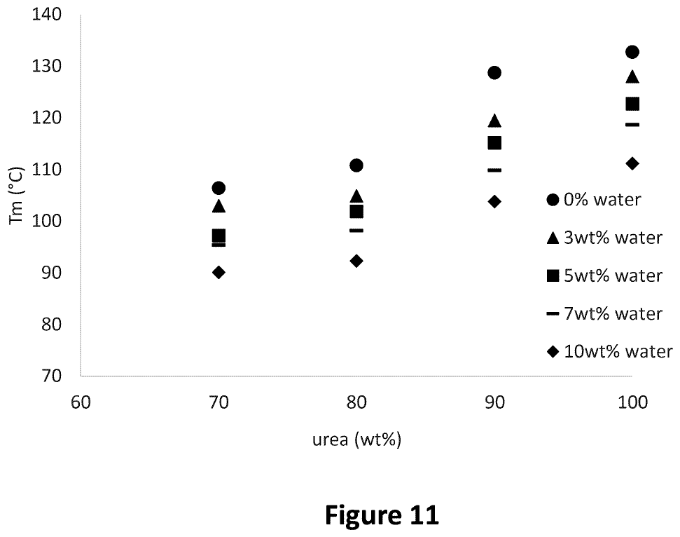

The melting point for different urea-ammonium thiosulfate blends was determined by mixing urea, ammonium thiosulfate (freeze dried from Thio-Sul®) and optionally water at different ratios to a total combined amount of 70 g, heating the mixture and determining the melting point by visual observation. The results are shown in FIG. 11, wherein the x-axis shows the urea wt. % on total solids basis. As can be seen in FIG. 11, the urea-ammonium thiosulfate blends exhibit a significant melting point depression at 70:30 and at 80:20 urea: ammonium thiosulfate (w/w) ratio's. The presence of water in an amount of 3-10 wt. % in the urea-ammonium thiosulfate blends decreased the melting point temperature.

As a comparison a urea-ammonium thiosulfate blend having a 99:1 urea: ammonium thiosulfate (w/w) ratio was similarly prepared. This urea-ammonium thiosulfate blend was solid at 128° C. and the melting point depression was insufficient at this composition.

Similar tests were performed using calcium thiosulfate and a melting point depression was also observed.

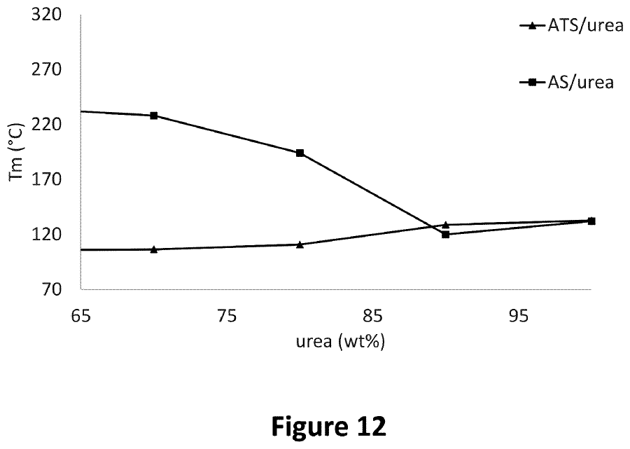

A comparison is visualized with melting temperatures of urea/ammonium sulfate blends obtained from literature with the experimentally determined urea/ammonium thiosulfate blend melting temperatures. The results are shown in FIG. 12. Is can clearly be seen that the melting temperature of urea/ammonium thiosulfate blends decreases further with increasing ammonium thiosulfate content in comparison to the melting temperature of urea/ammonium sulfate which increases above 10 solid wt % ammonium sulfate.

### Example 2

### Stability of Urea-Ammonium Thiosulfate Blends

An ammonium thiosulfate solution (Thio-Sul® from Tessenderlo Kerley) was freeze dried to obtain solid ammonium thiosulfate, which was blended with grinded urea powder into a homogeneous mixture. A master batch of the urea-ammonium thiosulfate blend having a 80:20 urea: ammonium thiosulfate (w/w) ratio was prepared and divided into different glass jars, containing 20 g powder blend each, which were all placed into an oil batch at a stable temperature of either 140° C. or 110° C. One glass jar was removed after a certain residence time being: 1 min, 2 min, 3 min, 5 min, 10 min and 15 min. The material was left to solidify at room temperature. Decomposition was follow by determining the ammonium thiosulfate content by means of titration for every sample.

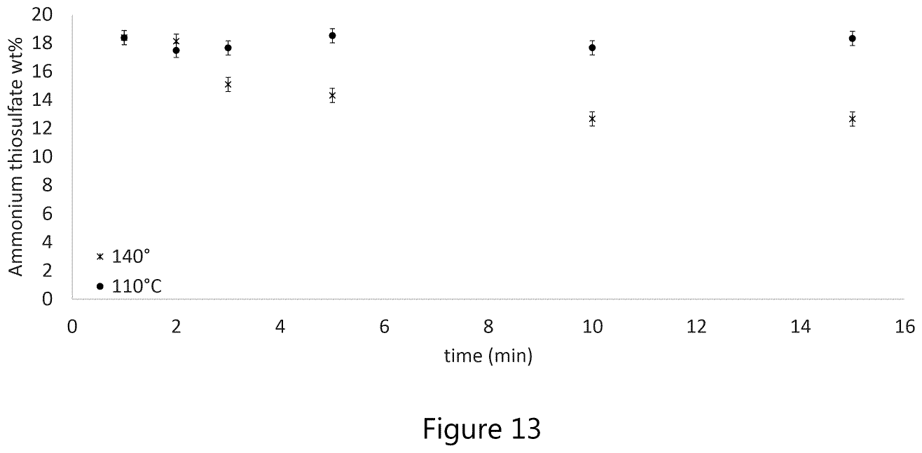

It can be seen from the results shown in FIG. 13 that ammonium thiosulfate decomposition is significantly lower at 110° C. than at 140° C. Hence, thanks to the melting point depression found with certain urea-ammonium thiosulfate blends described herein, enabling lower processing temperatures than for regular urea melts, the processing and provision of urea-ammonium thiosulfate blends is greatly facilitated.

Another urea-ammonium thiosulfate blend was prepared having a 80:20 urea: ammonium thiosulfate (w/w) ratio as described above with the exception that the material was solidified through fluid bed granulation and in the form of granules. This urea-ammonium thiosulfate blend was divided into different glass jars, containing 20 g granular blend each, which were all placed into an oil batch at a stable temperature of either 110° C., 120° C., 125° C., 130° C. or 140° C. One glass jar was removed after a certain residence time being: 1 min, 2 min, 3 min, 5 min, 10 min and 15 min. The material was left to solidify at room temperature. Decomposition was follow by determining the ammonium thiosulfate content by means of titration for every sample.

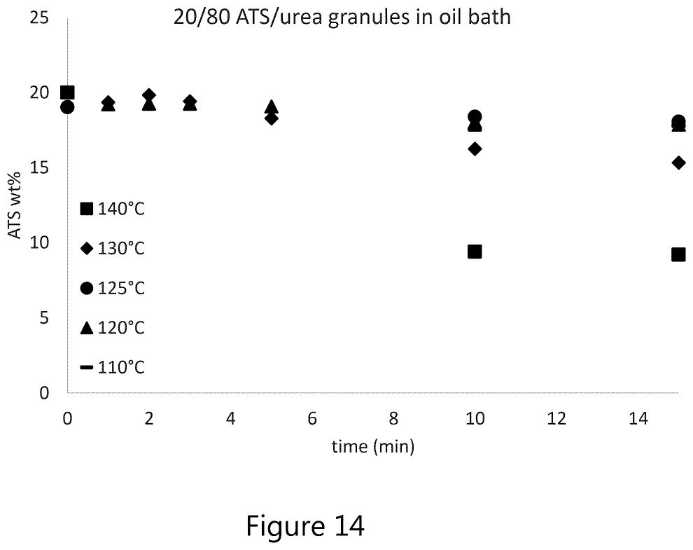

It can be seen from the results shown in FIG. 14 that ammonium thiosulfate decomposition is significantly lower at a temperature of <130° C. than at 140° C. Hence, despite this blend being in a different form the melting point depression was also found with certain urea-ammonium thiosulfate blends as described herein, to enable lower processing temperatures than for regular urea melts, which greatly facilitates the processing and provision of urea-ammonium thiosulfate blends.

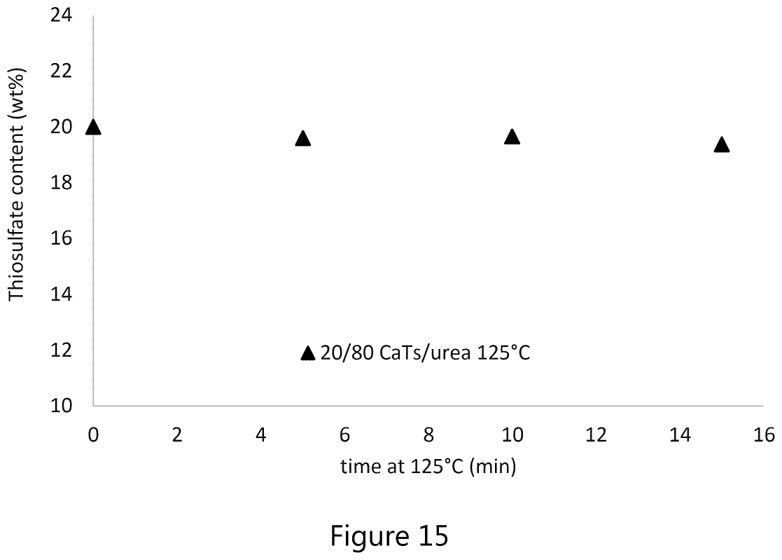

An urea-calcium thiosulfate blend having a 80:20 urea: calcium thiosulfate (w/w) ratio was similarly prepared to the urea-ammonium thiosulfate blend by freeze drying of calcium thiosulfate to obtain a dry powder product to prepare a physical blend with grinded urea. The urea-calcium thiosulfate blend had 20 g of the powder blend added to glass jars, which was placed in an oil bath at 125° C. One glass jar was removed after a certain residence time being: 5 min, 10 min and 15 min. The material was left to solidify at room temperature. Decomposition was follow by determining the calcium thiosulfate content by means of titration for every sample. It can be seen from the results shown in FIG. 15 that calcium thiosulfate decomposition is stable at a temperature of 125° C. within the standard error margin of +−0.5 CaTs % of the titration method.

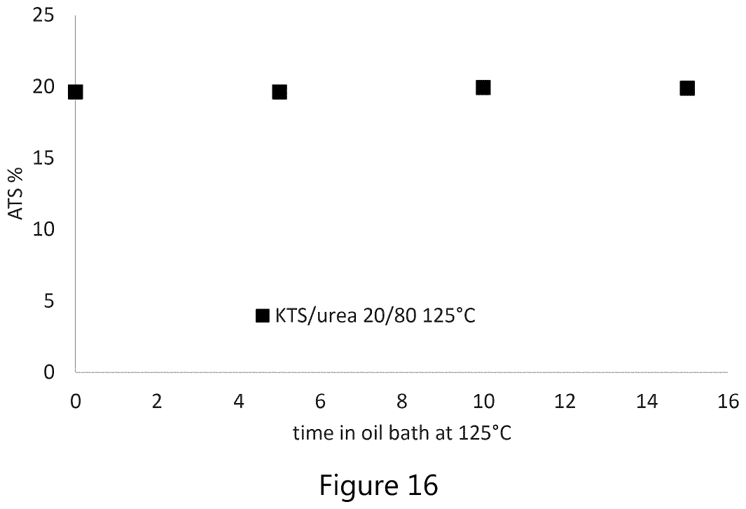

An urea-potassium thiosulfate blend having a 80:20 urea: potassium thiosulfate (w/w) ratio was similarly prepared to the urea-ammonium thiosulfate blend by freeze drying of potassium thiosulfate to obtain a dry powder product to prepare a physical blend with grinded urea. The urea-potassium thiosulfate blend had 20 g of the powder blend added to glass jars, which was placed in an oil bath at 125° C. One glass jar was removed after a certain residence time being: 5 min, 10 min and 15 min. The material was left to solidify at room temperature. Decomposition was follow by determining the potassium thiosulfate content by means of titration for every sample. It can be seen from the results shown in FIG. 16 that potassium thiosulfate decomposition is also stable at a temperature of 125° C.

1. A method for the production of a solid nitrogen fertilizer and a solid nitrogen-sulfur fertilizer, said method comprising the following steps:
(i) synthesizing urea from ammonia and carbon dioxide thereby obtaining a liquid aqueous composition comprising urea;
(ii) concentrating the aqueous composition obtained in step (i) to obtain a liquid urea melt comprising less than 5 wt % (by total weight of the melt) water, preferably comprising more than 95 wt. % (by total weight of the melt) urea;
(iii) submitting the urea melt of step (ii) to a solidification step in a solidification section wherein the melt is converted to a particulate solid, thereby obtaining the solid nitrogen fertilizer, and recovering a gas stream comprising urea from the solidification section;
(iv) recovering urea from the gas stream of step (iii), thereby obtaining an urea recyclate;
(v) providing a composition comprising a sulfur compound selected from the group consisting of thiosulphate salts, (bi)sulfite salts, polysulfide salts, (bi)sulfide salts, metabisulfite salts, dithionite salts, elemental sulfur and combinations thereof, preferably selected from the group consisting of thiosulphate salts, (bi)sulfite salts, polysulfide salts and combinations thereof;
(vi) submitting the urea recyclate of step (iv) to a concentration step and combining the composition provided in step (v) with the urea recyclate before, during and/or after the concentration step to obtain a concentrated nitrogen-sulfur stream;
(vii) submitting the concentrated nitrogen-sulfur stream to a solidification step in a solidification section, wherein the stream is converted to a particulate solid, thereby obtaining the solid nitrogen-sulfur fertilizer.

2. The method according to claim 1, wherein step (iv) comprises recovering urea from the gas stream by means of cyclones and/or filters, thereby obtaining urea dust, and optionally contacting said urea dust with an aqueous phase, thereby obtaining the urea recyclate in the form of an aqueous composition comprising at least 20 wt. % (by total weight of the composition) urea and at least 30 wt. % (by total weight of the composition) water, preferably in the form of an aqueous composition comprising 20-45 wt. % (by total weight of the composition) urea and 55-80 wt. % (by total weight of the composition) water.

3. The method according to claim 1, wherein step (iv) comprises separating urea dust from the gas stream by means of a scrubber wherein the gas stream is contacted with an aqueous phase, thereby obtaining the urea recyclate in the form of an aqueous composition, preferably comprising at least 25 wt. % (by total weight of the composition) urea and at least 30 wt. % (by total weight of the composition) water, preferably in the form of an aqueous composition comprising at least 25-45 wt. % (by total weight of the composition) urea and 55-75 wt. % (by total weight of the composition) water.

4. The method according to claim 3, comprising contacting in a first scrubber the gas stream of step (iii) with an aqueous phase which is substantially free of hydrochloric acid, sulphuric acid and nitric acid such that an urea recyclate which is substantially free of ammonium chloride, ammonium sulphate and ammonium nitrate is obtained; recovering the off-gas from the first scrubber and contacting the off-gas from the first scrubber in a second scrubber with an aqueous phase comprising hydrochloric acid, sulphuric acid and/or nitric acid, preferably sulphuric acid, such that an aqueous ammonium compound stream is obtained, and optionally combining at least part of the ammonium compound stream with the urea recyclate before the solidification of step (vii) and before, during and/or after combining the urea recyclate with the sulfur compound of step (v), such that the final nitrogen-sulfur fertilizer optionally comprises an ammonium compound selected from ammonium chloride, ammonium sulphate, ammonium nitrate and combinations thereof, preferably ammonium sulphate next to at least urea and the sulfur compound of step (v).

5. The method of claim 1, wherein the concentration step (vi) is performed in an evaporator and wherein the condensate recovered from the evaporator in step (vi) is at least partially recirculated to step (iv) to generate the urea recyclate obtained in step (iv).

6. The method of claim 5, wherein step (vii) comprises recovering from the solidification section a gas stream comprising urea and the sulfur compound, and combining said gas stream with the gas stream recovered from the solidification section of step (iii); and wherein step (iv) comprises recovering urea from the combined gas streams to obtain the urea recyclate.

7. The method according to claim 1, wherein the concentrated nitrogen-sulfur stream of step (vi) is an urea melt wherein the combined amount of urea and the sulfur compound comprised in the concentrated nitrogen-sulfur stream is at least 95 wt. % (by total weight of the concentrated nitrogen-sulfur stream).

8. The method according to claim 1, wherein the solid nitrogen fertilizer produced in step (iii) comprises more than 95 wt. % (by dry weight of the solid nitrogen fertilizer) urea, preferably comprises more than 98 wt. % (by dry weight of the solid nitrogen fertilizer) urea.

9. The method according to claim, wherein the method further comprises combining the urea recyclate of step (iv) with part of the liquid aqueous composition comprising urea of step (i) and/or part of the liquid urea melt of step (ii), before, during and/or after the concentration step (vi).

10. The method according to claim 1:
(A) for the simultaneous coproduction of a solid nitrogen fertilizer and a solid nitrogen-sulfur fertilizer wherein steps (ii) and (iii) are performed simultaneously with steps (vi) and (vii), wherein
step (ii) comprises concentrating the liquid composition of step (i) in a first evaporator as described herein;
step (vi) comprises concentrating the urea recyclate of step (iv) in a second evaporator as described herein, wherein the second evaporator employed in step (vi) is a distinct apparatus from the first evaporator employed in step (ii); and
step (iii) is performed in a first solidification apparatus and step (vii) is performed employing a second solidification apparatus distinct from the first solidification apparatus of step (iii);
or
(B) for the alternate production of a solid nitrogen fertilizer and a solid nitrogen-sulfur fertilizer wherein step (iii) is performed during a first period, and step (vii) is performed during a subsequent second period, wherein
step (ii) comprises concentrating the liquid composition of step (i) in an evaporator;
step (vi) comprises concentrating the urea recyclate of step (iv) in an evaporator, wherein the evaporator employed in step (vi) is preferably a distinct apparatus from the evaporator employed in step (ii);
step (vi) may be performed during the first and/or the second period, wherein if step (vi) is performed at least in part during the first period, the second evaporator employed in step (vi) is a distinct apparatus from the first evaporator employed in step (ii); and
step (iii) is performed in solidification apparatus and step (vii) is performed employing the same solidification apparatus as step (iii).

11. The method according to claim 1, wherein the solidification section of steps (iii) and (vii) each comprise a solidification apparatus independently selected from a prill tower, a rotoformer, a drum granulator and a fluidized bed granulator; and wherein the concentrated nitrogen-sulfur stream solidified in the solidification apparatus in step (vii) has a water content of less than 5 wt. % (by total weight of the concentrated nitrogen-sulfur stream).

12. The method according to a claim 1, wherein the amount of urea recovered in step (iv) is within the range of 0.5-5% of the urea fed to the solidification section of step (iii), preferably within the range of 2-5%.

13. A solid composition, preferably a solid fertilizer, comprising urea, a sulfur compound selected from the group consisting of thiosulphate salts, (bi)sulfite salts, polysulfide salts, (bi)sulfide salts, metabisulfite salts, dithionite salts, elemental sulfur and combinations thereof, preferably selected from the group consisting of thiosulphate salts, (bi)sulfite salts, polysulfide salts and combinations thereof, and an ammonium compound selected from ammonium sulphate and/or ammonium nitrate, and less than 5 wt. % (by total weight of the composition) water.

14. The solid composition of claim 13 comprising at least 50 wt. % urea (by total weight of the composition), at least 10 wt. % (by total weight of the composition) of a sulfur compound selected from the group consisting of thiosulphate salts, (bi)sulfite salts, polysulfide salts, (bi)sulfide salts, metabisulfite salts, dithionite salts, elemental sulfur and combinations thereof, preferably selected from the group consisting of thiosulphate salts, (bi)sulfite salts, polysulfide salts and combinations thereof, 5-35 wt. % (by total weight of the composition) of an ammonium compound selected from ammonium sulphate and/or ammonium nitrate, and less than 5 wt. % (by total weight of the composition) water.

15. The solid composition of claim 13, which is a single particle of a particulate solid, preferably a homogeneous single particle, more preferably a homogenous granule, prill, pellet or pastille.
